(19) United States
(12) Patent Application Publication
(10) Pub. No.: US 2024/0226747 A9
(43) Pub. Date: Jul. 11, 2024

(54) GAME SYSTEM, GAME METHOD, GAME PROGRAM, AND GAME SERVER

(71) Applicants: The Pokémon Company, Tokyo (JP); Tencent Technology ( Shenzhen ) Company Limited, Shenzhen (CN)

(72) Inventors: Masaaki HOSHINO, Tokyo (JP); Yuki Gabe, Tokyo (JP); Naoya Oikawa, Tokyo (JP); Norihiro Sera, Tokyo (JP); Yixiang Li, Shenzhen (CN); Siqin Yang, Shenzhen (CN); Xin Ding, Shenzhen (CN); Yihan Wu, Shenzhen (CN); Mochi Li, Shenzhen (CN)

(21) Appl. No.: 18/532,853

(22) Filed: Dec. 7, 2023

Related U.S. Application Data
(63) Continuation of application No. PCT/JP22/14262, filed on Mar. 25, 2022.

(30) Foreign Application Priority Data
Jun. 9, 2021 (JP) 2021-096046

(51) Int. Cl. A63F 13/58; A63F 13/35; A63F 13/847

(52) U.S. Cl. CPC A63F 13/58; A63F 13/35; A63F 13/847

(57) ABSTRACT

Provided are a game system, a game method, a game program, and a game server capable of, in a game in which a plurality of players can participate, contributing to a team through behaviors other than interpersonal battles in the game and encouraging fight together with other players. A game system 1 comprising: a character state decision unit 50 that is configured to decide a state of a neutral character based on a result of a fight between the neutral character and a player character; and a point giving control unit 62 that is configured to control a giving of points of the neutral character to a player, wherein the point giving control unit 62 is further configured to automatically give the points to the player if a first condition is satisfied, and cause a point object to appear in a play field and make the point object available for acquisition by any player of an ally team and an enemy team if a second condition is satisfied.

### CROSS-REFERENCE TO RELATED APPLICATIONS

This application is a continuation application of PCT Patent Application No. PCT/JP2022/014262, entitled “GAME SYSTEM, GAME METHOD, GAME PROGRAM, AND GAME SERVER” filed on Mar. 25, 2022, which claims all of priority to Japanese Patent Application No. 2021-096046, entitled “GAME SYSTEM, GAME METHOD, GAME PROGRAM, AND GAME SERVER” filed on Jun. 9, 2021, all of which are incorporated herein by reference in their entireties.

### TECHNICAL FIELD

The present disclosure relates to a game system, a game method, a game program, and a game server. In particular, the present disclosure relates to a game system, a game method, a game program, and a game server in which a plurality of players can play simultaneously via a communication network.

### BACKGROUND

In recent years, a type of game in which a plurality of players is divided into a plurality of teams (typically two teams), and victory condition is to destroy a base of an enemy team while cooperating with other players of a team to which a player belongs (ally team), has been actively played. This type of game is called multiplayer online battle arena (MOBA). MOBA has high playability since it allows team-level person-v-person battles.

However, in order to win a battle between characters controlled by humans, that is, a interpersonal battle, it requires skillfulness to operate characters, and requires a certain amount of training to be able to actually win against human-controlled characters. Furthermore, when a player who is unfamiliar with operations belongs to an ally team, in order for the ally team to win against an enemy team, other players, excluding the unfamiliar player, must support the unfamiliar player. Therefore, this unfamiliar player may hesitate to participate in the game out of concern that he/she may cause trouble for the ally team.

Therefore, conventionally, there is a known information processing system that comprises: an operation input receiving means configured to receive an operation input of a user; and an information processing means configured to perform an information process based on the operation input received by the operation input receiving means, wherein the information processing means includes: a game progression means which controls an own character in a virtual space based on the operation input to paint the virtual space in a corresponding color of the own character, and a battle determination means which performs a battle determination based on a painting state of a corresponding color of an enemy character, which is different from the corresponding color of the own character, to the virtual space and a painting state of the corresponding color of the own character to the virtual space (for example, see PTL 1). According to the information processing system described in PTL 1, by controlling the own character in the virtual space, the virtual space can be painted in the corresponding color of the own character, and the battle determination can be performed based on that painting state and the painting state of the corresponding color of the enemy character.

### SUMMARY

### Technical Problem

However, in the information processing system as described in PTL 1, although it is possible to contribute to the win of the ally team by painting the corresponding color to the virtual space, there may be less room to enjoy one of sources of playability in the MOBA, such as operating characters and examining the strategy of the ally team in consideration of interpersonal battles. Furthermore, in the information processing systems as described in PTL 1, it is sometimes difficult to lower psychological barriers to interpersonal battles for novice players who are hesitant to engage in interpersonal battles or for players who are unfamiliar with operations. Moreover, in conventional information processing systems, even though players are playing as a team, points that can be earned during a game are concentrated on players who are familiar with operations, and cooperative play with other players is reduced, which may impair the enjoyment of joint fight in the MOBA.

Therefore, it is an object of the present disclosure to provide a game system, a game method, a game program, and a game server, which allow a player to contribute to a team by an action other than an interpersonal battle in a game in which a plurality of players can participate, and encourage joint fight with other players.

### Means for Solving the Problems

In order to achieve the above object, the present disclosure provides a game system in which an ally team to which a player belongs and an enemy team to which another player belongs compete in a play field, and an outcome of a game is decided by comparing scores earned by the ally team and the enemy team, the game system comprising: a character state decision unit that is configured to decide a state of a neutral character which acts without being operated by the player and the another player and with which prescribed points are associated, based on a result of a fight in which the neutral character and a player character of the player fight; and a point giving control unit that is configured to control a giving of the prescribed points associated with the neutral character to the player, based on the state of the neutral character, wherein the point giving control unit is configured to automatically give the prescribed points to the player if a cumulative total of the prescribed points that are given to the player satisfies a first condition in relation to an upper limit set for the player, and causes a point object to appear in the play field and makes the point object available for acquisition by any player of the ally team and the enemy team if the cumulative total of the prescribed points that are given to the player satisfies a second condition in relation to the upper limit set for the player.

### Advantageous Effects of Invention

According to the game system, game method, game program, and game server of the present disclosure, it is possible to provide a game system, a game method, a game program, and a game server, which allow a player to contribute to a team by an action other than an interpersonal battle in a game in which a plurality of players can participate, and encourage joint fight with other players.

### BRIEF DESCRIPTION OF THE DRAWINGS

FIG. 1 is a schematic diagram of a game system according to the present embodiment.

FIG. 2 is a schematic diagram of a game play field for a game executed in the game system according to the present embodiment.

FIG. 3 is a functional configuration block diagram of the game system according to the present embodiment.

FIG. 4 is a data configuration diagram of each storage unit included in a storage unit according to the present embodiment.

FIG. 5 is a schematic diagram of a movement instruction to a player character by an input unit according to the present embodiment.

FIG. 6 is a schematic diagram of a fight between the player character and a neutral character in the game system according to the present embodiment.

FIG. 7 is a schematic diagram of the fight between the player character and the neutral character in the game system according to the present embodiment.

FIG. 8 is a schematic diagram of the fight between the player character and the neutral character in the game system according to the present embodiment.

FIG. 9 is a schematic diagram of joint fight between the player character and an ally character in the game system according to the present embodiment.

FIG. 10 is a schematic diagram of joint fight between the player character and the ally character in the game system according to the present embodiment.

FIG. 11 is a schematic diagram of point scoring in the game system according to the present embodiment.

FIG. 12 is a schematic diagram of point scoring in the game system according to the present embodiment.

FIG. 13 is a schematic diagram of a first special character in the game system according to the present embodiment.

FIG. 14 is a schematic diagram of the first special character in the game system according to the present embodiment.

FIG. 15 is a schematic diagram of a second special character in the game system according to the present embodiment.

FIG. 16 is a schematic diagram of a restriction generation unit in the game system according to the present embodiment.

FIG. 17 is a schematic diagram of appearance of point objects in the game system according to the present embodiment.

FIG. 18 is a schematic diagram of the appearance of the point objects in the game system according to the present embodiment.

FIG. 19 is a flow diagram of process in the game system according to the present embodiment.

FIG. 20 is a flow diagram of process in the game system according to the present embodiment.

FIG. 21 is a flow diagram of process in the game system according to the present embodiment.

FIG. 22 is a flow diagram of process in the game system according to the present embodiment.

FIG. 23 is a flow diagram of process in the game system according to the present embodiment.

### DETAILED DESCRIPTION OF THE EMBODIMENTS

### Embodiment

<Outline of Game System 1>

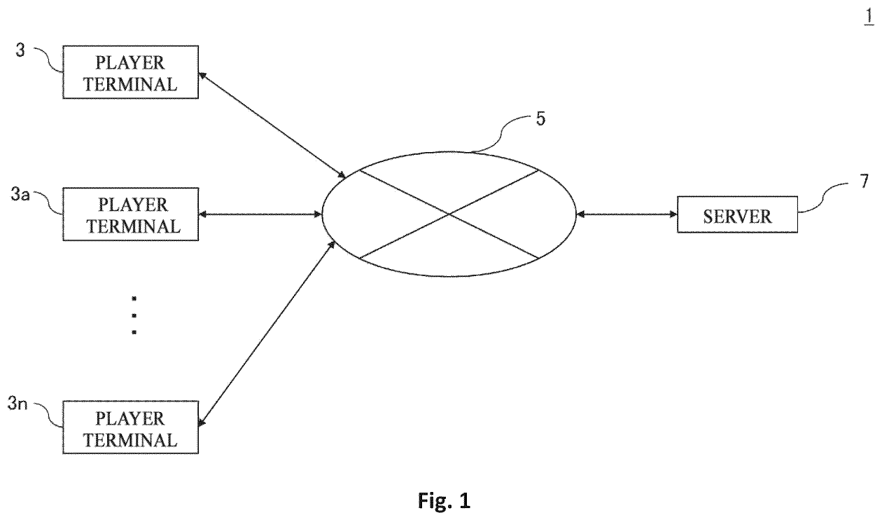

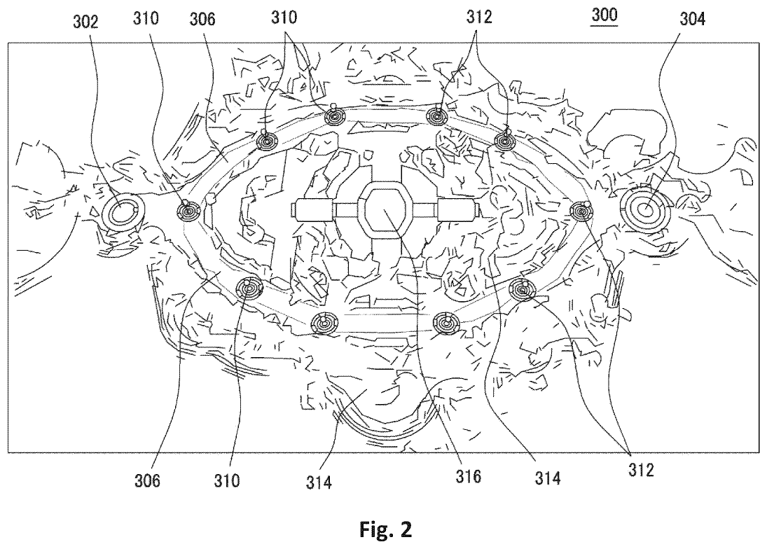

FIG. 1 shows an outline of a game system according to the present embodiment. Furthermore, FIG. 2 shows a schematic example of a play field for a game executed in the game system according to the present embodiment.

The game system 1 according to the present embodiment is a game system that can be executed on an information terminal 3 such as a smartphone, and in which the information terminals 3 of a plurality of players are connected to a server 7 via a communication network 5 so that the players can play a game simultaneously. In the game system 1, players are divided into at least two teams to compete against each other, one team (hereinafter sometimes referred to as “ally team”) composed of player characters of one or more players and the other team (hereinafter sometimes referred to as “enemy team”) composed of other player characters of one or more other players. The game system 1 decides a winning team of the game by comparing a score earned by the ally team with a score earned by the enemy team. The game system 1 may be a kind of Multiplayer online battle arena (MOBA). Here, the server 7 and the information terminals owned by the players (e.g., information terminals 3, 3a . . . and 3n) are connected, for example, via the communication network 5 so as to be capable of two-way communication. Furthermore, the game system 1 may be a server-client type game system.

Note that a character operated by a player per se is called a player character, a team to which the player belongs is called an ally team, a character operated by a player belonging to the ally team other than the player is called an ally player character, a team to which another player that the player fight against belongs is called an enemy team, and a character operated by another player belonging to the enemy team is called an enemy player character.

That is, in the game system 1, the game is executed by dividing players into an ally team to which a player character operated by a player belongs and an enemy team to which an enemy player character operated by another player belongs. Then, when each player's player character (i.e., player character, ally player character, and enemy player character) satisfies a prescribed condition during the game, the game system 1 scores points earned by each player, thereby turning the points into a score for a team to which each player belongs. At the end of the game time, the scores earned by these respective teams are compared to decide the outcome of the game.

For example, in the game system 1, the game is executed in a play field 300, which is a virtual space. As an example, as shown in FIG. 2, the play field 300 includes an ally headquarter 302 of the ally team to which a player character belongs, an enemy headquarter 304 of the enemy team to which an enemy player character belongs, one or more lanes 306 connecting the ally headquarter 302 and the enemy headquarter 304, one or more ally bases 310 provided along at least one lane 306 to a prescribed distance from the ally headquarter 302, one or more enemy bases 312 provided along at least one lane 306 to a prescribed distance from the enemy headquarter 304, a neutral region 314 provided between a plurality of lanes 306 and provided on at least unit of sides of the plurality of lanes 306, and a central part 316 provided at a position equidistant from the ally headquarter 302 and the enemy headquarter 304. The player character can, in principle, move freely to any desired position in response to the instruction of the player, except for areas of the play field 300 where movement is not allowed (e.g., walls, rocks, and ponds provided in the play field 300).

In the game system 1, a neutral character (NPC) is made to appear at a prescribed position in the lane 306 and/or the neutral region 314. The neutral character is a character that performs actions without being operated by any player. Further, the neutral character may be a character automatically controlled by the game system 1 and a character that is attacked and defeated by a player character, an ally player character, and/or an enemy player character, whereby points are given to the player who successfully defeats the neutral character. It may also be a character that can be acquired by the player. That is, the neutral character is associated with prescribed points in accordance with the type, status (e.g., level) or the like of the neutral character.

For example, when a player character attacks and defeats a neutral character that is within a prescribed range from the player character in response to the instruction of the player, the game system 1 gives points associated with the neutral character to the player who operates the player character. Furthermore, the game system 1 may cause the player to acquire the neutral character. When the player is made to acquire the neutral character, the game system 1 changes the neutral character into an ally character of the player character and gives the points the neutral character has to the player. As a result, the player acquires the points. The game system 1 stores this ally character in a virtual character storage area of the player.

Then, the game system 1 can, in response to the instruction of the player, cause the ally character to appear from the character storage area onto the play field 300 and can store the ally character from the play field 300 into the character storage area. When the player causes the ally character to appear in the play field 300, the game system 1 can also cause the ally character to automatically follow the player character and automatically attack a neutral character and/or an enemy player character that is within a prescribed range from the player character or the ally character (in other words, the ally character can fight together with the player character).

Furthermore, the game system 1 can also cause the player character to attack an enemy player character that is within a prescribed range from the player character, in response to the instruction of the player. When the player character attacks and defeats the enemy player character, the game system 1 gives prescribed points to the player who has the player character. In other words, in the game system 1, the player can not only engage in a interpersonal battle against the enemy player character by operating the player character, but also engage in a battle between the player character and the neutral character (a battle against the system) in accordance with the player's intention. As a result, the player can acquire points by having the player character operated by the player defeat the enemy player character or defeat the neutral character.

Then, when the player character is within a prescribed area of the play field 300 (e.g., within a prescribed range from the enemy base 312), the game system 1 can, in response to the instruction of the player, supply the points earned by the player to the enemy base 312, thereby turning these points into a score of the ally team. In other words, the ally team does not score until the points are turned into a score (hereinafter, converting points into a score is sometimes referred to as “scoring”). In this case, as the points are converted into the score, the game system 1 resets the points earned by the player up to the scoring to zero. Furthermore, when the points are set to zero and the ally character is stored in the character storage area, the game system 1 may erase the ally character or the ally character that appears in the play field 300 from the character storage area. Here, deleting the ally character means restricting the ally character so that it cannot appear in the play field 300 again during the same game play. This makes it impossible for the ally character to battle together with the player character. Furthermore, a predetermined durability value is set for the enemy base 312, and when a total value of points supplied to the enemy base 312 (hereinafter referred to as “supply value”) is equal to or greater than the durability value, the game system 1 stops the function of the enemy base 312. For example, the game system 1 can display the enemy base 312 being destroyed and indicate that the function of the enemy base 312 has stopped.

Moreover, in the game system 1, each player is provided with an upper limit to the cumulative total of points that can be earned (hereinafter sometimes simply referred to as “upper limit”) (note that, when points are given to a player, points may be given to a player character the player has, or an upper limit of points that can be earned by each of one or more player characters each player has may be set). Then, when the cumulative total of points earned by a player by having a player character defeat a neutral character, etc., exceeds the upper limit, the game system 1 converts a prescribed amount of points (e.g., some or all of the exceeded points) into point objects and causes the point objects to appear in the vicinity of the defeated neutral character or the like. Then, the game system 1 makes the point objects available for acquisition by any of player characters belonging to the ally team and the enemy team. In the game system 1, the player can have his/her own player character acquire the point object and turn the point corresponding to the acquired point object into his/her own point, as long as the upper limit of the cumulative total of points set for him/her is not exceeded.

Note that the upper limit of the cumulative total of points that can be earned in the game system 1 may be set in association with a player or set in association with a player character the player has (in other word, associated with the player). Furthermore, when a plurality of player characters are associated with a player and an upper limit is set for each player character, the upper limit for each player character may be the same or may be different for each player character. Moreover, when an upper limit is associated with a player, the upper limit for each player may be the same or may be different for each player, but it is preferable that the upper limit for each player is the same from the viewpoint of especially enabling players who are not familiar with the game to enjoy the game and to ensure the fairness of the game. Furthermore, the upper limit associated with a player or a player character may be changeable in accordance with the elapsed time of the game.

Thus, in the game system 1, when a player character operated by a player attacks and defeats a neutral character and/or an enemy player character, the player can obtain points and operate the player character to supply the obtained points to the enemy base, thereby turning the points into a score of the ally team. Here, in the game system 1, an upper limit is set for a cumulative total of points that a player can possess, and when the player has earned points in excess of the upper limit, prescribed points are made to appear in the play field as point objects. Then, the point object can be acquired by any of the player characters of players to become his/her own point, regardless of whether the team to which the player belongs is the ally team or the enemy team. On the other hand, when the cumulative total of points possessed by the player is below the upper limit, the game system 1 automatically gives the points that are earned through a fight against a neutral character or the like to the player. Therefore, if a player of a player character continues to acquire points through a one-on-one fight between the player character and a neutral character or an enemy player character, and has not performed the scoring of the points in a state where the earned points reach the upper limit of the points, the points to be earned subsequently will be converted into point objects because they exceed the upper limit, and the point objects will appear in the play field in a state where they can be acquired by any player character. In so doing, the point object is possibly taken away by an enemy player character. Therefore, when the points possessed by the player are below the upper limit, the player can concentrate on a one-on-one fight between the player character and an enemy player character or a fight against a neutral character and can play smoothly, and meanwhile, when the earned points reach the upper limit or are about to reach the upper limit, the player can advance the game by cooperating with player characters of other players of the ally team (e.g., other players who do not possess points up to the upper limit), so that even when points associated with a neutral character or the like that his/her own player character has defeated appear as the point objects, it is possible to give the ally team an advantage by having player characters of other players on the ally team acquire the point objects. Therefore, in the game system 1 according to the present embodiment, it is possible to encourage the progression of the game while cooperating with a plurality of players on the ally team (progression of the game through struggling jointly), in other words, it is possible to induce many-to-many game play. Furthermore, for example, by having a game player who is not familiar with game operations (beginner player) and a game player who is familiar with the game operations (advanced player) fight jointly, having the advanced player fight against the neutral characters or the enemy player characters to cause the point objects to appear, and having a player character of the beginner player acquire the appearing point objects, it is also possible to make the beginner player familiar with game operations.

Furthermore, in the game system 1, it is also possible to cause a player character to acquire a neutral character. In this case, the neutral character acquired by the player character can be made to behave together with the player character as an ally character (in this case, the ally character can be controlled to automatically fight together with the player character, and it moves to follow the player and performs attack action to neutral characters or enemy player characters within a prescribed periphery of the ally character), and on the other hand, when points earned by the player are scored, the ally character possessed by the player will be erased at the time point of scoring and cannot appear in the game again. As a result, in the game system 1, when a neutral character is acquired and turned into an ally character, the player can choose whether to score the points gained by acquiring the neutral character and erase the ally character, or to keep the ally character and use it to fight jointly without scoring the earned points, thereby improving the strategic nature of the game.

In addition, in the game system 1, a player can acquire points by battling against a neutral character without having to engage in a battle with an enemy player character, i.e., a interpersonal battle, and can make the earned points to be scored at the enemy base by having his/her player character perform a prescribed action, so even a player who is hesitant about the interpersonal battle or who is not good at the interpersonal battle can contribute to the team to which he/she belongs. In other words, in the game system 1, a player can enjoy the game without having to engage in the interpersonal battle. Furthermore, in the game system 1, the player can improve his/her proficiency in battles in the game through battles with neutral characters. As a result, according to the game system 1, the player can become familiar with battles, and his/her dislike of interpersonal battles gradually decreases.

Moreover, in the game system 1, when a player character defeats a neutral character or an enemy player character, etc., the player character obtains experience values, and when a total value of the earned experience values is equal to or greater than a prescribed value, that player character's appearance and abilities can be changed (hereinafter, this change is referred to as “evolution”). Through this evolution, the player character can improve its abilities or learn “skills” to attack neutral characters or enemy player characters. As a result, in the conventional MOBA, a player character had to acquire and equip prescribed items in the game in order to improve the player character's attack power, etc., but in the game system 1, the player character automatically learns “skills” as it evolves, so the player character can be strengthened without complicated operations. Furthermore, in the game system 1, since the appearance of the player character can be changed through “evolution”, the player can also grasp at a glance how strong the player character is.

Note that the information terminals 3, 3a, . . . 3n are information terminals such as cell phones, smartphones, notebook computers, tablet PCs, PCs, portable game consoles, and/or home game consoles. When a plurality of information terminals exist, the type of each information terminal may be different. In addition, the details of the game system 1 according to the present embodiment will be explained below, but it should be noted that the names, numerical values, etc. in the above description and the following description are only examples, and the present disclosure is not limited to these proper names and numerical values, and that these proper names and numerical values are not necessarily related to the actual proper names and numerical values.

<Details of Game System 1>

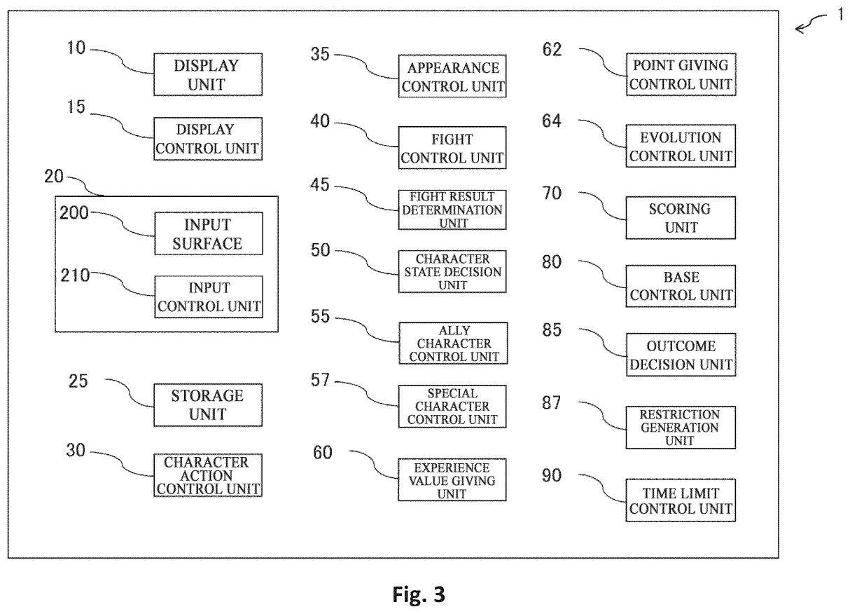

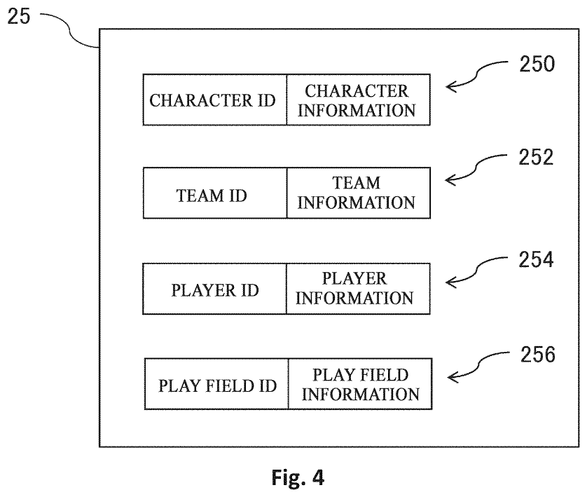

FIG. 3 shows an example of functional configuration of the game system according to the present embodiment. Furthermore, FIG. 4 shows an example of data configuration of each storage unit included in a storage unit of the game system according to the present embodiment.

[Outline of Configuration of Game System 1]

The game system 1 according to the present embodiment is a game system in which an ally team to which a player and an ally player belong and an enemy team to which an enemy player belongs compete in a play field 300, and the outcome of a game is decided by comparing scores earned by these respective teams. The game system 1 comprises a display unit 10 that is configured to display the play field 300, player characters, or the like, a display control unit 15 that is configured to control the display of the display unit 10, an input unit 20 that is configured to receive instructions from a player, a storage unit 25 that is configured to store various information used in the game, a character action control unit 30 that is configured to control actions of the player characters, an appearance control unit 35 that is configured to control the appearance of a neutral character and/or a special character, a fight control unit 40 that is configured to control a fight between a player character and various other characters, a fight result determination unit 45 that is configured to determine the result of the fight between the player character and the various other characters, a character state decision unit 50 that is configured to decide a state of a character, an ally character control unit 55 that controls actions, etc., of an ally character, a special character control unit 57 that is configured to control actions, etc., of a special character, an experience value giving unit 60 that is configured to give experience values to the player character, a point giving control unit 62 that is configured to give points to the player character or the player, an evolution control unit 64 that is configured to control evolution of the player character, a scoring unit 70 that is configured to convert points into a score, a base control unit 80 that is configured to control an ally base and an enemy base, a outcome decision unit 85 that is configured to decide the outcome of the game, a restriction generation unit 87 that is configured to generate a prescribed restriction between bases, and a time limit control unit 90 that is configured to control a time limit of the game. Note that the special character is a character among the neutral characters (NPC) that can fight against the player character and belongs to the team to which the player character belongs, but is not stored in the character storage area, even when the player character wins a fight between the special character and the player character (typically, it is a character that is displayed in the play field 300 until a prescribed condition is achieved.). Furthermore, the special character may be a character among the neutral characters that generates an effect in the game that is advantageous to the player character and/or the team to which the player character belongs when the player character wins a fight between the special character and the player character. Note that, in the following description, unless otherwise specified, the neutral character shall include the special character.

The storage unit 25 includes a character information storage section 250 that is configured to store information regarding player characters, neutral characters, and/or special characters, a team information storage section 252 that is configured to store information related to teams participating in the game, a player information storage section 254 that is configured to store information regarding players, and a play field information storage section 256 that is configured to store information regarding the play field 300.

The game system 1 may not only have the above plurality of components in a physically identical device or location, but may also have some of the above plurality of components provided in physically separate positions. In this case, each component may be connected, for example, through a communication network such as the Internet. For example, the game system 1 may have an external server carry some of functions of the components. Furthermore, the game system 1 may be configured as one or more servers. In this case, the game system 1 is configured by combining information terminals, and components of one server and components of other servers. Furthermore, in the present embodiment, an aggregation of prescribed components can be understood as one “information processing device”, and the game system 1 may be formed as an aggregation of a plurality of information processing devices. The manner of allocation of a plurality of functions required to realize the game system 1 according to the present embodiment to one or more pieces of hardware can be properly decided in light of processing capability of each piece of hardware and/or specifications required for the game system 1 or the like. Moreover, various information stored by the storage unit 25 may be updated by a user's instruction or information received via the input unit 20, or may be updated at any time by obtaining prescribed information from a prescribed server existing outside the game system 1.

[Details of Configuration of Game System 1]

In the following description, a case where a game provided by the game system 1 is mainly executed by a player using the information terminal 3 (e.g., a smartphone, a tablet terminal, and a PC) will be described as an example. The information terminal 3 consists of at least the display unit 10 and the input unit 20.

(Display Unit 10 and Display Control Unit 15)

The display unit 10 is controlled by the display control unit 15 and is configured to display information regarding the game, including the play field 300 on which the game is executed, player characters (ally player characters and enemy player characters), neutral characters, special characters, and/or other items. The display unit 10 is configured to output various processing results and information stored by the storage unit 25 in a manner that is perceivable by the player. Specifically, the display control unit 15 is configured to cause various processing results in the components, information stored by the storage unit 25, and the like to be displayed on the display unit 10 as data in a prescribed format, still images, moving images, and/or text, or the like. The display unit 10 may display information received from an external server.

(Input Unit 20, Input Surface 200, and Input Control Unit 210)

The input unit 20 is configured to receive prescribed instructions, operations, and other inputs from the player. The input unit 20 is configured to supply the instructions to prescribed components of the game system 1. Each component that receives the instruction performs a prescribed function. For example, the input unit 20 is a touch panel, a tablet, a mouse, a motion sensor, or the like. In the present embodiment, an example will be described in which the input unit 20 is a touch panel included in the information terminal 3. Note that the touch panel may be capable of multi-touch detection. Specifically, the touch panel as the input unit 20 has the input surface 200 to which operations or the like from the player are input and the input control unit 210 is configured to obtain information regarding the operations input to the input surface 200. The touch panel is arranged to overlap the display unit 10, and the surface of the touch panel corresponds to the input surface 200.

For example, the display unit 10 is provided with an area for receiving prescribed instructions, and the input surface 200 detects a prescribed instruction at a position specified by an operation (e.g., a touch operation, a tap operation, a slide operation) of the player on the area of the input surface 200. The input surface 200 supplies the detected information, i.e., information indicating a prescribed instruction at the detected position, to the input control unit 210. The input control unit 210 obtains the information indicating the prescribed instruction from the input surface 200 and supplies the information to the prescribed components of the game system 1.

(Storage Unit 25)

The storage unit 25 is configured to store various information related to the game system 1. Each storage unit included in the storage units 25, in response to a request from another component of the game system 1, supplies prescribed information to a prescribed component. Note that in the game system 1, when one game ends, a next game may be executed without taking over a situation of that one game. Therefore, in the game system 1, for all of the player characters, ally player characters, and enemy player characters, information regarding experience values, levels, statuses, the owned points, the owned ally characters, and/or evolution states, etc. is returned to an initial state and the next game starts. That is, the game system 1 may return at least unit of the information stored by the storage unit 25 to an initial value each time a new game starts.

(Storage Unit 25: Character Information Storage Unit 250)

The character information storage section 250 is configured to store various information regarding a character (character information) in association with a character ID that identifies the character. Here, the character includes a player character, a neutral character, and a special character. The character information includes, for example, a name of the character, a status or parameter of the character (e.g., experience value, level, hit points (HP), attack power, defense power, and speed), points associated with the character (points owned by the character), an upper limit of points that the character can possess (the upper limit of points that the character can possess may be the same regardless of the type of the character, or may differ depending on the type of the character), attacking methods that the character can normally use, skills that the character can use when a prescribed condition is satisfied, whether or not the character has evolved, and the character ID of the character to which the character evolves when the character evolves, or the like. Note that in the game system 1, the player can arbitrarily select a player character to be used in the game from a plurality of characters at the start of the game. Here, when the character is a player character, the status of the character, points owned by the character, whether or not the character has evolved, etc. are reset each time a new game starts. Note that the points owned by the character when the character is a player character are synonymous with the points associated with the player.

Note that “skills” may include a skill that takes away points of an enemy player character (points associated with an enemy player), an ally character of the enemy player character that enters the character storage area of the enemy player character, and/or an ally character of the enemy player character appearing in the play field 300.

(Storage Unit 25: Team Information Storage Unit 252)

The team information storage section 252 is configured to store various information regarding a team (team information) in association with a team ID that identifies the team. The team information includes, for example, information regarding players forming the team (e.g., player IDs as described below), and information such as character IDs of characters (e.g., special characters) associated with the team in the game and a score earned by the team in the game.

Here, a team is composed of one or more players. In the game system 1, one or more players forming a team can be randomly decided at the start of the game, or one player can invite other players to form a team. Therefore, the information regarding the players as the team information that is stored by the team information storage section 252 associated with the team ID may be reset each time a new game is executed. Note that the team information stored by the team information storage section 252 may be reset each time a game ends.

Furthermore, the team information storage section 252 can temporarily store character IDs. For example, when a player character belonging to a team defeats a special character during game execution, the team information storage section 252 may store the character ID of the special character for a certain time and erase it after the certain time has elapsed. Moreover, the team information storage section 252 may store the character IDs of the special characters stored during the game execution in chronological order. Furthermore, the team information storage section 252 may erase all character IDs stored during the game execution at the time when the game ends.

(Storage Unit 25: Player Information Storage Unit 254)

The player information storage section 254 is configured to store information regarding a player who plays the game. Specifically, the player information storage section 254 is configured to store player information in association with a player ID that identifies the player. The player information includes, for example, the player's name, neutral characters that the player has acquired by winning battles in the game, rewards that the player has earned in the game (including points, scores, experience values, or the like earned through game execution), information regarding the upper limit of the cumulative total of points that the player can possess in the game, and information regarding the player characters used by the player in the game. The player information storage section 254 can update or store, in chronological order, information regarding the neutral characters as the player information each time the player wins against a neutral character in a battle in the game and acquires the neutral character. Note that among the player information stored by the player information storage section 254, the information regarding the neutral characters acquired by the player and rewards earned by the player in the game, etc. is reset each time the game ends. Alternatively, information regarding the neutral characters acquired by the player and the rewards earned by the player in the game, etc. as the player information stored by the player information storage section 254 in association with the player ID may be reset each time the game is executed. Note that what is reset here is information for continuing a series of play from the start of the play until the outcome of the team is determined, and game play history information (the number of wins and losses in battles, the number of the earned experience values), which is the result of a series of game play, is stored in the player information storage section 254 without being reset. For example, the number of types of player characters and the number of types of skills of a player character that the player can use by winning a prescribed number of times by repeating a series of game play increase.

(Storage Unit 25: Play Field Information Storage Section 256)

The play field information storage section 256 is configured to store information regarding the play field 300. Specifically, the play field information storage section 256 stores play field information in association with a play field ID that identifies a play field. The play field information is, for example, information regarding the play field's name, the arrangement and number of various elements forming the play field, and the like. Note that the game system 1 can also use a predetermined play field in a fixed manner, and in this case, the storage unit 25 may not have the play field information storage section 256.

(Character Action Control Unit 30)

The character action control unit 30 is configured to control actions of a player character of a player within the play field 300 based on the instruction of the player. Specifically, the character action control unit 30 controls the actions of the player character within the play field 300, such as moving, stopping, attacking, defending, and executing the scoring of points, based on the instruction of the player received by the input unit 20. The display unit 10 is controlled by the display control unit 15 and displays the actions of the player character controlled by the character action control unit 30.

(Appearance Control Unit 35)

The appearance control unit 35 is configured to control the appearance of neutral characters and/or special characters in the play field 300. The appearance control unit 35 causes a neutral character and/or special character to appear at a predetermined location in the play field 300 at a predetermined time interval or random time interval. It is preferable that the appearance control unit 35 causes the neutral character and/or special character to appear at a predetermined time interval from the viewpoint of equalizing opportunities of players on these respective teams encountering the neutral character and/or special character.

Here, from the viewpoint of equalizing opportunities for contact with a neutral character between a player character belonging to a first team (e.g., an ally team to which a player belongs) and a player character belonging to a second team (e.g., an enemy team), a plurality of locations for the appearance of the neutral character can be provided, for example, in line-symmetrical positions when a prescribed virtual straight line passing through the center of the play field 300 is used as a symmetric axis. For example, in an approximately elliptical play field 300 shown in FIG. 2, the appearance control unit 35 causes a neutral character to appear at a prescribed position in the lane 306, with a short axis passing through the center of the play field 300 as a symmetric axis, and also causes a neutral character of the same type to appear at a position that is lineally symmetrical with the position. Note that a plurality of locations for the appearance of the neutral character may be provided at point-symmetrical positions with the center of the play field 300 as a symmetry point.

Furthermore, from the viewpoint of equalizing opportunities for contact with a special character, the appearance control unit 35 also causes the special character to appear in an area where each team can equally come into contact with it. For example, the appearance control unit 35 causes the special character to appear at specific positions in the play field 300, as an example, near an intersection of the lane 306 and the short axis passing through the center of the play field 300 at a predetermined time interval when a central part 316 and/or the play field 300 is approximately elliptical. Furthermore, when the appearance control unit 35 causes a special character to appear, the display unit 10 can be controlled by the display control unit 15 and displays information (e.g., a text display) indicating that the special character has appeared at a prescribed position on the display unit 10. Note that the appearance control unit 35 may make the appearance frequency of the special character lower than the appearance frequency of the neutral character.

(Fight Control Unit 40)

When a neutral character, a special character, and/or an enemy player character exists within a prescribed range from a player character, when the player's attack instruction for these characters (hereinafter sometimes referred to as “target character”) is received by the input unit 20, the fight control unit 40 initiates a fight (battle) between the player character and the target character and controls the fight. For example, the fight control unit 40 causes the player character to attack the target character in response to the instruction of the player received by the input unit 20 and inflicts damage based on the attack on the target character. Furthermore, when the player character is attacked by the target character, the fight control unit 40 inflicts damage based on the attack on the player character.

For example, the fight control unit 40 changes the player character's status based on the damage received by the player character from the target character (as an example, decreases HP indicating the damage that the character can withstand), and changes the target character's status based on the damage received by the target character from the player character. The display unit 10 is controlled by the display control unit 15 and displays the situation of the fight controlled by the fight control unit 40 between the player character and the target character, the damage inflicted on the opponent character, and the like. Note that even when there is no target character within a prescribed range from the player character, the fight control unit 40 can also cause the player character to execute an attack action when the player's attack instruction is received via the input unit 20.

Furthermore, the player character may have one or more attack means. That is, in addition to the normally available attack means that can attack the target character at any time during the game, the player character may also have access to predetermined skills based on experience values earned by the player character. For example, a prescribed experience value is associated with a skill as character information that is stored by the character information storage section 250 in association with a character ID, and when the experience value earned by the player character is equal to or greater than the prescribed experience value, the fight control unit 40 permits the player character to use the skill. Furthermore, when an instruction to use a skill is received from the player via the input unit 20, after the player character has activated the prescribed skill, the fight control unit 40 may prohibit the player character from activating the skill again until a prescribed time has elapsed. The fight control unit 40 supplies the fight result determination unit 45 with information indicating changes in the player character's status and changes in the target character's status caused by the fight.

(Fight Result Determination Unit 45)

The fight result determination unit 45 determines a fight result between the player character and the target character in the fight controlled by the fight control unit 40. Specifically, the fight result determination unit 45 determines which character has won/lost the fight based on changes in the player character′ status and changes in the target character′ status. For example, each character has hit points (HP) as one of its statuses, and the fight result determination unit 45 determines that the character whose HP first becomes zero through the fight has lost and the character whose HP remains has won.

Furthermore, when three or more characters are competing against each other, for example, when a fight in which a player character of the ally team (ally player character) and a player character of the enemy team (enemy player character) attack a neutral character or a special character is being executed, the fight result determination unit 45 may determine that the character who last attacked to reduce the HP of the neutral character or special character to zero has satisfied the condition for acquiring the neutral character (has won) (i.e., it may determine that the ally player character has defeated the neutral character or the special character). Furthermore, the fight result determination unit 45 may determine that the character with the greatest number of attacks (number of hits) until reducing the HP of the neutral character or special character to zero, or the character with the largest total amount of damage (i.e., a total value of HP reduction) inflicted on the neutral character or special character, has won. The fight result determination unit 45 supplies information indicating the fight result to the character state decision unit 50, the experience value giving unit 60, and the point giving control unit 62.

(Character State Decision Unit 50)

The character state decision unit 50 is configured to decide the state of the player character and/or the target character based on the determination result of the fight result determination unit 45. When the determination result (i.e., the fight result) of the fight result determination unit 45 indicates the win of the player character, the character state decision unit 50 decides the state of the player character and/or the target character depending on the type of the target character. Then, the character state decision unit 50 supplies information indicating a decision result to the ally character control unit 55 and the special character control unit 57.

For example, when the target character is a neutral character, the character state decision unit 50 may associate the neutral character with the player when a prescribed condition for acquisition is satisfied. That is, the character state decision unit 50 associates the neutral character beaten by the player character with the player. The character state decision unit 50 stores the character ID of this neutral character as the ally character in the player information storage section 254 as the player information in association with the player ID. Accordingly, a state in which the player has acquired this neutral character is decided. Then, the character state decision unit 50 erases the display of this neutral character from the play field 300. That is, the character state decision unit 50 causes the display control unit 15 to erase the display of the neutral character on the display unit 10. Furthermore, in accordance with the association of the neutral character with the player, the character state decision unit 50 changes the neutral character into the ally character and associates it with the player. Furthermore, the ally character may be stored in the virtual character storage area for the player. The display control unit 15 can, for example, display the virtual character storage area at a prescribed position on the display unit 10. The character storage area may be displayed in the play field 300 in a superposed manner. Thus, in this case, it is decided that the neutral character is in a state of becoming the ally character of the player and a state of being stored in the character storage area is decided. Furthermore, when a neutral character is acquired, the neutral character may not be stored in the character storage area. In this case, the point giving control unit 62 described below gives points associated with the neutral character to the player. Furthermore, the neutral character may be made to appear in the play field 300 and behave as the ally character.

Here, a case where, in a state where the neutral character is already associated with the player as the ally character, the player character fights against a new neutral character and wins will be described. In this case, the character state decision unit 50 overwrites the character ID of the ally character, which is stored in the player information storage section 254 in association with the player ID, with a character ID of the newly defeated neutral character. That is, in one aspect of the game system 1, there may be only one ally character (i.e., an ally character that is a neutral character that the player has acquired and can possess) associated with the player, and when the player character defeats a plurality of neutral characters, the neutral character who is the last opponent against whom the player character won will be associated with the player and become the ally character. Then, the character state decision unit 50 erases the ally character already stored in the character storage area and newly stores the newly defeated neutral character as the ally character in the character storage area.

Furthermore, one aspect of a case where, in a state where the ally character is out of the character storage area to the play field 300, the player character and/or the ally character fights against a new neutral character and wins will be described. In this case, the character state decision unit 50 overwrites the character ID of the ally character, which is stored in the player information storage area 254 associated with the player ID (this character ID is the character ID of the ally character that has appeared in the play field 300), with the character ID of the newly defeated neutral character. Then, the character state decision unit 50 erases the ally character appearing in the play field 300 and stores the newly defeated neutral character in the character storage area as the ally character. Thus, in this case, a state in which the newly defeated neutral character becomes the ally character of the player and is stored in the character storage area is decided, and after being stored in the character storage area, a state in which the original ally character that appeared in the play field 300 has been erased is decided. Note that it is also possible that the original ally character is not erased and a plurality of ally characters are stored in the character storage area. In this case, it is preferable to display a plurality of display icons in the character storage area so as to be associated with a plurality of characters.

Furthermore, when a player character has won against a neutral character, the character state decision unit 50 may associate the neutral character with the team to which the player of the player character belongs. For example, the character state decision unit 50 stores the character ID of this neutral character as an ally character in the team information storage section 252 as the team information in association with the team ID. Accordingly, it is possible to put it into a state where the team to which the player of the player character belongs acquires this neutral character as the ally character. Note that, in this case, the character state decision unit 50 may set an upper limit to the number of ally characters that can be associated with the team. However, the player who can obtain points a neutral character has by defeating the neutral character is the player of the player character who defeated the neutral character. Moreover, in this case, the neutral character acquired by the team may be stored in the character storage area of any player belonging to the team, or the neutral character acquired by the team may not be stored in the character storage area (in this case, it is possible to leave this neutral character appearing in the play field 300).

Moreover, when a player character has won against a special character, the character state decision unit 50 associates the special character with the team to which the player of the player character belongs. For example, the character state decision unit 50 stores the character ID of this special character in the team information storage section 252 as the team information in association with the team ID. However, in this case, the character state decision unit 50 may leave the special character appearing in the play field 300 without storing it in the character storage area, or may erase it from the play field 300 without storing it in the character storage area 320.

Note that, when a plurality of characters (ally player characters and/or enemy player characters) attacked a neutral character, and the determination result of the fight result determination unit 45 indicates that the player character who defeated the neutral character is the player character who last attacked to reduce the HP of the neutral character to zero, the character state decision unit 50 associates the neutral character to the player of this player character. Furthermore, when a plurality of characters attacked a special character, and the determination result of the fight result determination unit 45 indicates that the player character who defeated the special character is the player character who last attacked to reduce the HP of the special character to zero, the character state decision unit 50 associates the special character to the team to which this player character belongs.

Furthermore, when the target character is an enemy player character, the character state decision unit 50 makes it into a state of causing the enemy player character that has lost the fight (e.g., an enemy character whose prescribed parameter such as HP has become zero) to move from the lost position in the play field 300 to the enemy headquarter 304 after a prescribed time has elapsed (i.e., after a prescribed return time has elapsed). Then, the character action control unit 30 controls the actions of the enemy player character moved to the enemy headquarter 304 in response to the instruction from the player of the enemy player character. Note that the character state decision unit 50 can provide an advantageous effect (e.g., a HP recovery effect) to the enemy player character existing within the enemy headquarter 304.

Note that, when the player character has lost, regardless of which character the target character is, the character state decision unit 50 makes it into a state of causing the player character to move from the lost position in the play field 300 to the ally headquarter 302 after a prescribed time has elapsed (i.e., after a prescribed return time has elapsed). In this case, the character action control unit 30 may recover the HP, etc. of the player character to full. Then, the character action control unit 30 controls the actions of the player character moved to the ally headquarter 302 in response to the instruction from the player of the player character. Note that the character state decision unit 50 can provide an advantageous effect (e.g., a HP recovery effect) to the ally player character existing within the ally headquarter 302.

(Ally Character Control Unit 55)

The ally character control unit 55 is configured to control actions of an ally character based on information indicating the decision result of the character state decision unit 50. Specifically, if a neutral character is associated with a player, the ally character control unit 55 performs such a control that a prescribed effect can be generated by an ally character in the play field 300. That is, if the player has an ally character, the ally character control unit 55 controls the generation of effects based on the characteristics of the ally character to the play field 300.

For example, when the decision result of the character state decision unit 50 indicates that the player character satisfied the condition for acquiring the neutral character in the fight between the player character and the neutral character, the player has the neutral character as the ally character, and the ally character is stored in the character storage area. Therefore, the ally character control unit 55 performs such a control that the appearance of the ally character from the character storage area onto the play field 300 and the storage of the ally character into the character storage area can be repeated. In this case, an effect occurs in which the appearance of the ally character in the play field 300 and the storage of the ally character into the character storage area can be repeated. For example, the ally character control unit 55 prohibits the appearance of the ally character from the character storage area to the play field 300 for a prescribed time after the acquisition of the neutral character by the player (i.e., after the neutral character disappears from the play field 300 and is stored in the character storage area as the ally character), and after the prescribed time has elapsed, the ally character control unit 55 enables the appearance of the ally character from the character storage area to the play field 300 and the storage of the ally character from the play field 300 into the character storage area in response to the instruction of the player received via the input unit 20.

Furthermore, when the ally character is made to appear in the play field 300 in response to the instruction of the player, the ally character control unit 55 executes control to cause the appearing ally character to automatically follow the player character around the player character. That is, the ally character control unit 55 causes the ally character to follow the player character moving within the play field 300 in response to the instruction of the player received via the input unit 20. Then, the ally character control unit 55 causes the ally character to automatically execute attacks against enemy player characters, other neutral characters, and/or special characters that exist within a prescribed range from the ally character appearing in the play field 300. Note that the ally character control unit 55 prohibits the ally character from attacking an ally player character and/or an ally character of the ally player character.

Then, the ally character control unit 55 is configured to cause the ally character to automatically attack enemy player characters, other neutral characters, and/or special characters, and inflicts damage based on the attack on the “enemy player characters, other neutral characters, and/or special characters (attack target characters)”. Among the attack target characters located within a prescribed range from the ally character, an attack target character closest to the ally character may be attacked, or an attack target character being attacked by the player character may be attacked. Furthermore, when the ally character is attacked by the attack target character, the ally character control unit 55 inflicts damage based on the attack to the ally character. Then, the ally character control unit 55 determines a fight result between the ally character and the attack target character. That is, the ally character control unit 55 determines which character has won/lost the fight based on changes in the status of the ally character and changes in the status of the attack target character. For example, the ally character control unit 55 determines that the character whose HP becomes zero has lost. The ally character control unit 55 supplies the determination result to the point giving control unit 62.

Furthermore, when a player acquires a neutral character as an ally character, the ally character control unit 55 can generate a prescribed effect (e.g., an effect of a skill or skill set for the ally character) that is associated with the ally character in advance in a prescribed area of the play field 300. For example, when a player character of the team to which the player belongs exists in the prescribed area of the play field 300, the ally character control unit 55 can generate an advantageous effect (e.g., HP recovery) on the player character. Meanwhile, when a player character of a team hostile to the team to which the player belongs exists in the prescribed area, the ally character control unit 55 can generate a disadvantageous effect (e.g., reduction in attack power) on the player character.

(Special Character Control Unit 57)

The special character control unit 57 is configured to refer to information indicating the decision result received from the character state decision unit 50, and when the fight result between the player character and the special character indicates the win of the player character and the information indicating that the special character is associated with the team to which the player character belongs (i.e., the ally team) has been obtained, the special character control unit 57 generates a prescribed effect. The prescribed effect is an effect in which the team to which the player character who has won against the special character belongs has an advantage in the progression of the game. Specifically, one or more of the following effects can be generated in combination.
When the special character is associated with the ally team, the special character is not erased from the play field 300 and parameters of one or more player characters of the ally team that exist within a prescribed range centered on the special character are changed to be advantageous in the progression of the game.
When the special character is associated with the ally team, the special character is not erased from the play field 300 and parameters of one or more player characters of the enemy team who exist within a prescribed range centered on the special character are changed to be disadvantageous in the progression of the game.
When the special character is associated with the ally team, the special character is not erased, and the special character is made to automatically advance toward an enemy base of the enemy team provided in the play field 300 and made to automatically attack enemy characters in the surrounding.
When the special character is associated with the ally team, the special character is not erased, the special character is made to automatically advance toward an enemy base of the enemy team provided in the play field 300, and the special character automatically attacks enemy characters that exist within a prescribed range centered on the special character.
When the special character is associated with the ally team, the special character is erased from the play field 300 and parameters of a player character (or player characters) of the ally team and/or parameters of an ally base (or ally bases) are changed to be advantageous in the progression of the game.
When the special character is associated with the ally team, the special character is erased from the play field 300, and parameters of a player character (or player characters) of the enemy team and/or parameters of an enemy base (or enemy bases) are changed to be disadvantageous in the progression of the game.
When the special character is associated with the ally team, the special character is not erased, and the special character is made to automatically advance toward an enemy base of the enemy team provided in the play field 300, and when the special character intrudes within a prescribed range from the enemy base, parameters of the enemy base are changed to be advantageous for the ally team in the progression of the game.

Here, examples of the special character include various characters having various characteristics. Examples of the special character include, for example, a special character (hereinafter sometimes referred to as “first special character”) that, when lost to a player character, takes over points the player has, or a special character (hereinafter sometimes referred to as “second special character”) that has points equal to or greater than a prescribed value in advance, and that, when lost to a player character, is associated with the team (ally team) to which the player character belongs, and moves toward an enemy base while attacking the enemy player character, or a special character (hereinafter sometimes referred to as “third special character”) that has points equal to or greater than a prescribed value in advance, and that, when lost to a player character, allows unit of the points to be associated with the player having the player character, and that is erased from the play field 300 and generates a prescribed effect on the enemy base.

Specifically, when a player character and the first special character fight against each other, the special character control unit 57 refers to information indicating the decision result received from the character state decision unit 50, and if the fight result between the player character and the first special character indicates the win of the player character, the special character control unit 57 causes the first special character to take over the points owned by the player who defeated the first special character. Then, the special character control unit 57 controls the first special character and causes the first special character to progress toward an enemy base 312 of the enemy team closest to a spot where the first special character lost to the player character. When the first special character enters within a prescribed range from the enemy base 312, the special character control unit 57 supplies information indicating that the first special character is located within the range to the scoring unit 70.

Furthermore, when the first special character is attacked by an enemy player character, the special character control unit 57 decreases the HP of the first special character in response to the attack. Then, the special character control unit 57 can, when the HP of the first special character becomes zero, cause the first special character to disappear. In this case, the special character control unit 57 may also erase the points taken over by the first special character from the player.

Moreover, when a player character and the second special character fight against each other, the special character control unit 57 refers to information indicating the decision result received from the character state decision unit 50, and if the fight result between the player character and the second special character indicates the win of the player character, the special character control unit 57 causes the second special character to belong to the team of the player character. Then, the special character control unit 57 controls the second special character and causes the second special character to progress toward an enemy base 312 of the enemy team closest to a spot where the second special character lost to the player character. The special character control unit 57 may cause the second special character to attack an enemy player character that exists within a prescribed range from the second special character. When the second special character enters within a prescribed range from the enemy base 312, the special character control unit 57 supplies information indicating that the second special character is located within the range to the scoring unit 70.

Furthermore, when the second special character is attacked by an enemy player character, the special character control unit 57 decreases the HP of the second special character in response to the attack. Then, the special character control unit 57 can, when the HP becomes zero, cause the second special character to disappear.

Moreover, it is possible to associate points close to the upper limit of the cumulative total of points set for the player, points equal to or greater than the upper limit, or points exceeding the upper limit with the third special character. Then, when a player character and the third special character fight against each other, the special character control unit 57 refers to information indicating the decision result received from the character state decision unit 50, and if the fight result between the player character and the third special character indicates the win of the player character, the special character control unit 57 erases the third special character from the play field 300. Furthermore, as will be described in detail later, the point giving control unit 62 gives at least some or all of the points of the third special character to the player of the player character or causes point objects to appear in the play field 300, and further, the base control unit 80, etc. generates a prescribed effect on the enemy player character and/or the enemy base.

(Experience Value Giving Unit 60)

The experience value giving unit 60 is configured to give an experience value to a player character. The experience value is a value earned by the player character, and the level is a numerical value determined depending on the accumulated total of experience values to be given, and is a numerical value representing the rank of the player character. Note that, when the experience value earned by the player character achieves a prescribed condition (e.g., when it exceeds a predetermined threshold value), the level of the player character can be raised in stages.

The experience value giving unit 60 is configured to give a prescribed experience value to the player character based on information indicating the fight result received from the fight result determination unit 45. That is, when the player character wins a fight against a neutral character and/or a special character, and/or when the player character wins a fight against an enemy player character, the experience value giving unit 60 gives an experience value to the player character. The experience value giving unit 60 may make the experience value to be given in the case where the player character wins against the enemy player character higher than the experience value to be given in the case where the player character wins against the neutral character. Furthermore, the experience value giving unit 60 can give a prescribed experience value to the player character based on the passage of the game time, give an experience value to the player character by having the player character supply points to an enemy base, and/or give a prescribed experience value to the player character when information from the base control unit 80 described below indicates the destruction of an enemy base by the player character.

Furthermore, the experience value giving unit 60 can continuously give a prescribed amount of the experience value to the player character from the time when the game starts to the time when the game ends, and on the other hand, when the player character lost a fight against another character, a neutral character, and/or a special character, and the character state decision unit 50 causes the player character to move to the ally headquarter 302, the experience value giving unit 60 is capable of not giving an experience value to the player character for a period of time from the time when the player character lost to the time when the movement to the ally headquarter 302 is completed.

Moreover, the game system 1 can cause an item, whose experience value can be earned by the item being acquired by the player character, to appear at a predetermined position in the play field 300, appear by defeating the neutral character, or the like. When the player character acquires the item, the experience value giving unit 60 gives the player character the experience value. The experience value giving unit 60 supplies information regarding the experience value given to the player character to the evolution control unit 64.

(Point Giving Control Unit 62)

The point giving control unit 62 is configured to control the giving of prescribed points associated with the neutral character (including special character) to the player. For example, the point giving control unit 62 controls, based on the determination results of the fight result determination unit 45 and/or the ally character control unit 55, the giving of points possessed by the neutral character associated with the player to the player. That is, when the player character wins against the neutral character in fight against the neutral character, the point giving control unit 62 gives the points possessed by the neutral character to the player. Furthermore, the point giving control unit 62 also gives prescribed points to the player when the player character wins against an enemy player character in fight against the enemy player character.

Note that the point giving control unit 62 may give prescribed number of points to the player when the player character wins against a special character in fight against the special character. However, since the special character has an advantageous effect on the team to which the player character who wins against the special character belongs, from a viewpoint of game balance and the like, the point giving control unit 62 may not give the prescribed number of points to the player when the player character wins against the special character.

Then, when the points are given to the player, the point giving control unit 62 adds the points already possessed by the player to the points to be given and causes the player to possess the points after the addition. Here, an upper limit is set for the points that can be possessed (held) by the player (for example, an upper limit can be set such that the upper limit number of points is 50 points, 100 points, etc.).

In this case, if the cumulative total of the prescribed points that are given to the player satisfies a first condition set for the player, that is, if the cumulative total satisfies the first condition in relation to the upper limit set for the player, the point giving control unit 62 automatically gives the prescribed points to the player. The first condition is, for example, one of the following conditions.
A case where the cumulative total of the prescribed points that are given is below the upper limit of the cumulative total of points that can be earned, which is set for the player.
A case where the cumulative total of the prescribed points that are given is equal to or less than the points obtained by subtracting the predetermined points from the upper limit of the cumulative total of points that can be earned, which is set for the player, or below the obtained points.

On the other hand, if the cumulative total of the prescribed points that are given to the player satisfies a second condition different from the first condition set for the player, that is, if the cumulative total satisfies the second condition in relation to the upper limit set for the player, the point giving control unit 62 causes point objects corresponding to a prescribed number of points to appear in the play field 300. The point giving control unit 62 makes the point objects available for acquisition by both the player character of each of players on the ally team and the enemy player character of each of players on the enemy team. The second condition is, for example, one of the following conditions.
A case where the cumulative total of the prescribed points that are given is equal to or greater than an upper limit of the cumulative total of points that can be earned, which is set for the player, or exceeds the upper limit.

For example, when the cumulative total of points that are given to a player exceeds the upper limit set for the player, the point giving control unit 62 generates point objects corresponding to the surplus points obtained by subtracting the upper limit from the cumulative total and makes it appear in the play field 300. The point giving control unit 62 generates point objects corresponding to at least some or all of the surplus points. For example, when the surplus points are “a” points (where a is a positive number), the point giving control unit 62 can either make all of the “a” points into point objects, or can make the remaining points after subtracting prescribed “b” points (where b is a positive number and a>b is satisfied) from the “a” points into point objects. Then, the player of the player character that has acquired the point objects acquires the points corresponding to the acquired point objects as his/her own points within a range that does not exceed the upper limit set for himself/herself. Note that, when a player character acquires the point objects and thereby exceeds the upper limit of points set for the player of the player character, the point giving control unit 62 can cause the exceeded points to newly appear in the play field as point objects or can make it impossible to acquire point objects that exceed the upper limit. On the other hand, when the cumulative total of points that are given to the player is below the upper limit set for the player, the point giving control unit 62 automatically gives the points to the player.

Furthermore, when the player character wins against a neutral character in fight against the neutral character, the point giving control unit 62 causes point objects to appear in the vicinity of the location where the neutral character was defeated, and when the player character wins against a special character in fight against the special character, the point giving control unit 62 causes point objects to appear in the vicinity of the location where the special character was defeated. In this case, if the result of the fight between the player character and the special character indicates the win of the player character, the point giving control unit 62 may cause at least some or all of the points associated with the special character to appear in the play field as point objects.

Specifically, when the points owned by the player character reaches the upper limit, the point giving control unit 62 does not give points to the player even if the player character newly defeats a neutral character, but converts the points associated with the neutral character into point objects and causes the point objects to appear in the play field 300. In this case, unless the possessed points are reduced to zero through a scoring process by the scoring unit 70 described below or below the upper limit, the point giving control unit 62 prohibits the point giving to the player of the player character even if the player character newly defeats a neutral character, while executing the conversion of the points associated with the neutral character to point objects. In this way, by setting an upper limit to the points that can be possessed, it becomes easier for the player to have an incentive for the scoring process by the scoring unit 70 described below, and by causing the point objects to appear, it becomes easier for the player to have an incentive for a plurality of player characters to fight jointly.

Note that the point giving control unit 62 may generate one point object for one point when the surplus point is one point, or may generate one point object for x points when the surplus points are x points (where x is an integer equal to or greater than 2). Furthermore, there are no particular limitations on the size, color, and/or shape or display style of the point object, as long as it is of a size, color, and/or shape or display style that can be understood to be a point object. Moreover, the point object can continue to be displayed on the game field from the time point of its appearance on the game field until it is acquired by one player character, or it can be erased after a certain time has elapsed.

Furthermore, when a player character of a player having points lost the fight against an enemy player character, a special character, and/or a neutral character, the point giving control unit 62 may reduce the points possessed by the player by a prescribed amount. Moreover, when a determination result indicating that an ally character in the play field 300 has lost the fight against a player character, another neutral character and/or special character is obtained from the ally character control unit 55, the point giving control unit 62 may reduce the points possessed by the player who has the ally character by a prescribed amount. Note that the point giving control unit 62 causes the display unit 10 to display the number of points possessed by the player near the player character and/or near the character storage area.

Note that if, in a state where a neutral character is already associated with the player (i.e., a state where an ally character already exists), the player character fights against a new neutral character and wins, the character state decision unit 50 may erase the ally character stored in the character storage area. Furthermore, if, in a state where an ally character is out of the character storage area to the play field 300, the player character and/or the ally character fights against a new neutral character and wins, the character state decision unit 50 may erase the ally character that is out in the play field 300. In these cases, although the ally character has been erased, the point giving control unit 62 does not have to reduce the points possessed by the player, or does not have to change the points that can be earned by the player depending on the remaining HP of the ally character at the time when the new neutral character is defeated.

(Evolution Control Unit 64)

The evolution control unit 64 is configured to evolve a player character based on an experience value given to the player character by the experience value giving unit 60. Specifically, the evolution control unit 64 may evolve the character when the player character reaches a predetermined level and/or when an experience value equal to or higher than a prescribed value is earned. The evolution control unit 64 may enable the player character to use a prescribed skill in response to the evolution of the player character. Furthermore, the evolution control unit 64 may change the content of the skills that can be used by the player character and/or effects of the skills according to the level of the player character.

Thus, in the game system 1, a prescribed skill can be used by the player character based on the experience value earned by the player character. Therefore, in the game system 1, unlike games in the related art, the player does not need to purchase items such as weapons using in-game currency or the like in the game. Therefore, the player character can be smoothly strengthened without complicated operations and the game can be enjoyed.

(Scoring Unit 70)

When at least one of the player character and the ally character is located in a prescribed area provided in the play field 300, the scoring unit 70 is configured to set the points given to the player as a score of the ally team. Specifically, the scoring unit 70 converts the points possessed by the player into the score of the ally team of the player in response to a prescribed operation of the player received via the input unit 20 when at least one of the player character and the ally character is located in a prescribed range from the enemy base 312 of the enemy team provided in the play field 300. In this case, the character state decision unit 50 erases the ally character stored in the character storage area or the ally character appearing in the play field 300 when the scoring unit 70 turns the points into a score of the ally team. Moreover, the scoring unit 70 supplies a supply value corresponding to the score to the enemy base 312 and accumulates the supply value in the enemy base 312. The scoring unit 70 supplies the score of each team to the outcome decision unit 85 and supplies information regarding the supply value accumulated in the enemy base 312 to the base control unit 80.

Here, when the scoring unit 70 converts the points of the player into the score of the ally team (that is, when the points are scored), and accumulates the supply value corresponding to the points in the enemy base 312, the scoring unit 70 may complete scoring and accumulation when a predetermined time (hereinafter referred to as “scoreable time”) has elapsed. In other words, the scoring unit 70 may choose not to complete the scoring and accumulation of the supply value until the scoreable time has elapsed from the time when the player character enters within the prescribed range from the enemy base 312 or the time when the player character receives a prescribed instruction from the player after the player character enters within the prescribed range. For example, the scoring unit 70 starts the measurement of the time from the time when the prescribed instruction is received from the player, and completes the scoring and accumulation at the time when the time of continued acceptance of the prescribed instruction matches the predetermined scoreable time.

Specifically, the scoring unit 70 is configured to start measuring time from the time when the scoring instruction of the player received via the input unit 20 is received in a state where the player character enters within the prescribed range from the enemy base 312, and completes the scoring process and accumulation process of the supply value at the timing when the acceptance of the scoring instruction continues and the scoreable time has elapsed. For example, the scoring unit 70 starts measuring the scoreable time from the start of a “long press” instruction by the player that is received via the input unit 20.

Furthermore, a parameter (including a prescribed flag) about the scoreable time is set in advance for each of the ally bases 310 and each of the enemy bases 312. The parameter may be a parameter about the length of the scoreable time, a parameter indicating the relationship between the points the player has and the scoreable time, and the like. For example, the parameter may be as follows.
A parameter that associates the length of the scoreable time with each base. The scoreable time of each base may be the same or different.
A parameter that associates points possessed by a player whose player character enters within a prescribed range from a base and the scoreable time with each base. For example, a parameter that varies the scoreable time in accordance with the points possessed by the player, as an example, a parameter that increases the scoreable time as the player possesses more points, and shortens the scoreable time as the player possesses fewer points.

Note that in one enemy base 312, the scoring unit 70 can score the points until the durability value of the one enemy base 312 described below reaches the upper limit. Furthermore, the scoring unit 70 may not start the lapse of a predetermined time when the player character only enters a prescribed range from the enemy base 312, and may start the lapse of the time after the player performs the scoring operation.

Furthermore, when a prescribed special character (e.g., a first special character) belonging to the ally team exists within a prescribed range from an enemy base 312, the scoring unit 70 may shorten the predetermined time required to complete the scoring and accumulation of the supply value. In this case, a player character belonging to the ally team that exists within a prescribed range from this special character and also exists within a prescribed range from the enemy base 312 can, at the time when the shortened predetermined time has elapsed, perform the scoring of the points possessed by the player of the player character and supply a supply value corresponding to the score obtained by scoring to the enemy base 312.

Moreover, when information indicating that the first special character is located within the prescribed range from the enemy base 312 is received from the special character control unit 57, the scoring unit 70 can at least turn the points taken over by the first special character into a score of the ally team and also supply a supply value corresponding to the score to the enemy base 312, and then accumulate the supply value in the enemy base 312. Furthermore, when information indicating that the second special character is located within the prescribed range from the enemy base 312 is received from the special character control unit 57, the scoring unit 70 can turn the points the second special character has into a score of the ally team and also supply a supply value corresponding to the score to the enemy base 312, and then accumulate the supply value in the enemy base 312.

Moreover, when the points possessed by the player are turned into a score of the ally team of the player, the scoring unit 70 restricts the generation of effects of the ally character. For example, the scoring unit 70 erases the ally character stored in the character storage area or the ally character appearing in the play field 300. Here, the ally character may be erased immediately after scoring, or the ally character may be erased after a prescribed time further elapses after scoring. Note that the scoring unit 70 may not erase the ally character, but change its status. For example, the scoring unit 70 may decrease the HP, attack power, defensive power, etc. of the ally character as points are scored. Accordingly, the player can choose whether to score the points even if the ally character is weakened, or to leave the points unscored and use the ally character as a joint fight member without weakening it. Furthermore, when turning the points into a score of the ally team, the scoring unit 70 may eliminate the effect caused by the ally character that occur in a prescribed area of the play field 300.

(Base Control Unit 80)

First, a predetermined durability value is set for each base, i.e., the ally base and the enemy base. When a plurality of bases exist, the durability value of each base may be the same or different. However, from the viewpoint of improving the strategic nature of the game, etc., when a plurality of bases exist, an upper limit can be set on the durability value of each base and the durability value of each base can be different. For example, when a plurality of enemy bases 312 exist in the play field 300, the durability value of the enemy base 312 may be set lower as closer to the ally headquarter 302, and the durability value of the enemy base 312 may be set higher as farther away from the ally headquarter 302. For the enemy base 312 closest to the enemy headquarter 304 (final base), it is not necessary to set a substantial upper limit on the durability value thereof. Note that a high durability value corresponds to an increase in the number of points that the opponent team can score. Then, when a total value of supply values accumulated in the enemy base 312 by the scoring unit 70 becomes equal to or greater than the durability value, the base control unit 80 stops the function of the enemy base. The base control unit 80 controls the ally base 310 in the same manner. The base control unit 80 supplies information indicating the control result to the experience value giving unit 60 and the outcome decision unit 85.

Note that, when a plurality of bases exist, the base control unit 80 can stop function from the base near the headquarter of the team to which the player character belongs (the ally headquarter 302 for the ally team, the enemy headquarter 304 for the enemy team). For example, when the player character is a player character of the ally team, and a plurality of enemy bases 312 exist at intervals from a side close to the ally headquarter 302 toward the enemy headquarter 304, the base control unit 80 can prevent the function of an enemy base 312 next to one enemy base 312 closest to the ally headquarter 302 (that is, the enemy base 312 second close to the ally headquarter 302) from being stopped only after stopping the function of the one enemy base 312 (that is, after destroying the one enemy base 312).

Furthermore, when a player character of the team to which a predetermined base belongs is within a predetermined range from the base (for example, when a player character of the ally team or an ally player character is within the predetermined range from the ally base), the base control unit 80 can generate an effect that is advantageous to the player character. The advantageous effect is, for example, to gradually recover the HP of the player character of the ally team within the predetermined range from the ally base with a lapse of time, to improve the attack power, the defense power, and the like for a certain period of time by a certain percentage, and the like. Note that, once the player character of the team to which the base belongs enters the predetermined range from the base, the base control unit 80 may continuously generate the advantageous effect for a predetermined time even when the player character goes out of the predetermined range.

Note that, when a player character of one team and/or an ally character of the player character exists within a predetermined range from a base of the other team, the base control unit 80 may cause the base to perform an attack on the player character and/or the ally character of the player character within the range. However, from a viewpoint of easiness of intuitively understanding the progress of the game, the base control unit 80 may not cause the base to attack the characters.

(Outcome Decision Unit 85)

The outcome decision unit 85 is configured to terminate the game when a predetermined game time has elapsed, and decides the outcome of the game based on the score of each team at an end time. The outcome decision unit 85 decides the outcome of the game based on information received from the scoring unit 70 and/or information received from the base control unit 80. That is, the outcome decision unit 85 decides the outcome of the game based on a total score of the score obtained by scoring the points according to instructions of the player and the score obtained by scoring the points according to actions of the special character, rather than the points possessed by each player. The outcome decision unit 85 compares the scores of the teams and decides a team having a highest score as a winning team. The outcome decision unit 85 causes the display unit 10 to display the outcome of each team together with the score of each team.

(Restriction Generation Unit 87)

Within the play field 300, a plurality of bases of each team are provided at intervals. That is, a plurality of bases of the ally team (ally base) and a plurality of bases of the enemy team (enemy base) are provided at predetermined intervals. When a player character of a team different from a team to which one base and another base next to the one base belong and an ally character of the player character invades between these bases, the restriction generation unit 87 applies a restriction to the movement of the player character and the ally character. The restriction includes, for example, a restriction that slows down the movement speed, an effect that reduces the HP, and the like. For example, when the player character of the ally team and/or the ally character invades between the one enemy base and the other enemy base next to the one enemy base, the restriction generation unit 87 can slow down the movement speed of the player character and/or the ally character. The restriction generation unit 87 may display a situation in which the movement is limited on the display unit 10. For example, the restriction generation unit 87 may display the situation in which the movement is limited by superimposing a predetermined mark, pattern, or the like around the player character and/or the ally character whose movement is limited.

Here, when a prescribed restriction is applied between the one base and the other base located next to the one base, the restriction generation unit 87 releases the prescribed restriction when the function of at least one of the one base or the other base is stopped by the base control unit 80. Furthermore, the restriction generation unit 87 can also enable stopping of the function of a base located next to one base of one team near the headquarter of the other team on condition that the function of the one base is stopped. That is, when a plurality of bases (for example, enemy bases) exist, the restriction generation unit 87 enables stopping of the function of the enemy base second closest to the ally headquarter (that is, enables an ally player character to destroy this enemy base) after the function of the enemy base closest to the ally headquarter is stopped (that is, after an ally player character destroys this enemy base).

(Time Limit Control Unit 90)

In the game system 1, a time limit for executing the game is set in advance. Furthermore, in the play field 300, an extension base capable of extending the time limit may be provided, or it may appear after a predetermined time has elapsed from the start of the game. The time limit control unit 90 extends the time limit by a prescribed time when one or more player characters belonging to the ally team exist within a prescribed range from the extension base for a prescribed time (hereinafter sometimes referred to as “extendable time”). Here, the extension base may be destructible by an opponent player character attacking and dealing prescribed damage. Furthermore, when one or more player characters belonging to the ally team are within a prescribed range from the extension base and an enemy player character attacks the one or more player characters of the ally team, the time limit control unit 90 may reset count of the extendable time or extend the extendable time itself.

[Example of Actions of Input Unit of Game System 1]

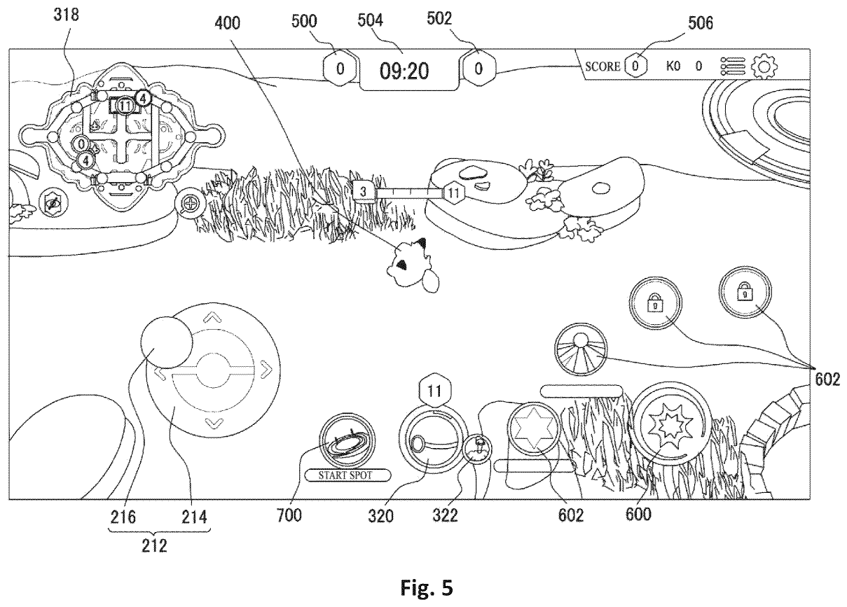

FIG. 5 shows an outline of an example of a movement instruction and the like to the player character by the input unit in the game system according to the present embodiment.

In the game system 1, the player can operate a player character 400 in the play field 300, which is a virtual space, by using the information terminal 3 provided with the touch panel as an example. Here, the game system 1 displays a movement instruction input area 212 for receiving the movement instruction to the player character 400 on the display unit 10 in a manner that can be perceived by the player. The movement instruction input area 212 includes a direction display area 214 indicating a movement direction of the player character 400, and a direction instruction unit 216 that receives the movement direction and the movement instruction of the player character 400 from the player.

For example, as shown in FIG. 5, the display control unit 15 is configured to cause the direction display area 214 to be displayed in a prescribed area of the display unit 10. Then, when the input unit 20 does not receive the movement instruction for the player character 400 from the player or at a moment when the input unit 20 receives the movement instruction, the display control unit 15 causes the display unit 10 to display the direction instruction unit 216 at a prescribed position (for example, center) of the direction display area 214. Then, when the input unit 20 receives the movement instruction from the player for the player character 400, for example, when a finger of the player touches the vicinity of the direction display area 214 of the touch panel and the movement direction and the movement instruction (for example, a movement instruction by sliding the finger in a prescribed direction) of the player character 400 by the finger of the player are received, the direction instruction unit 216 is displayed at a position touched by the finger (hereinafter, the position where a finger that was not in contact with the touch panel touches the touch panel is referred to as an “initial position”). Note that the direction instruction unit 216 is displayed in an area that can be superimposed and displayed on the direction display area 214.

Then, as shown in FIG. 5, the input unit 20 is configured to detect a current position of the finger on the touch panel (hereinafter, the position where the finger is currently in contact with the touch panel is referred to as the “current position”, in which stage it is assumed that the finger is not substantially separated from the touch panel from the “initial position” to the “current position”). The display unit 10 causes the display unit 10 to display how the direction instruction unit 216 is moved to a prescribed position around the direction display area 214, which is a position corresponding to a direction from the initial position to the current position, based on the detection by the input unit 20. In the example of FIG. 5, the movement instruction of the player character 400 is input in an upper left direction of the play field 300. Then, the character action control unit 30 moves the player character 400 based on the instruction received by the input unit 20. In the example of FIG. 5, the player character 400 moves in the upper left direction.

Note that the direction instruction unit 216 may be moved and displayed inside of and along the periphery of the direction display area 214. Then, the input control unit 210 may erase the display of the direction instruction unit 216 when the finger stops touching the touch panel. When the finger subsequently touches the vicinity of the direction display area 214, the input control unit 210 repeats the same control as described above. Furthermore, in the above example, the input control unit 210 receives the instruction from the player via the touch panel, but the input control unit 210 can also receive the instruction from the player via another input unit 20 such as a mouse or a keyboard.

Furthermore, the display unit 10 is configured to display an attack instruction area 600 that receives an attack instruction for the player character 400 to attack a target character such as a neutral character or an enemy player character, and a skill generation area 602 that receives a generation instruction of a prescribed skill. The input control unit 210 receives instructions from the player to the attack instruction area 600 and the skill generation area 602, and supplies the received instructions to the fight control unit 40. The fight control unit 40 controls the fight between the player character 400 and the target characters based on the received instructions. Note that, when use of the prescribed skill by the player character 400 is not permitted, a mark indicating that the skill cannot be used is displayed in the skill generation area 602. When the use of the skill is permitted by acquisition of experience values, level up, evolution, and the like, a mark indicating the skill that can be used is displayed in the skill generation area 602.

Moreover, the display unit 10 can display, in prescribed areas, an overall view 318 that is a reduced map of the entire play field 300, the character storage area 320; a stored character presentation 322 that presents the ally character stored in the character storage area 320; an ally team score 500 that indicates the score of the ally team; an enemy team score 502 that indicates the score of the enemy team; a remaining game time 504 that indicates a remaining time of the game time; and a player score 506 that indicates the score of the player per se. In the overall view 318, positions of the ally player character, the enemy player character, the neutral character, and/or the special character may be displayed in real time, and for the ally player character and the enemy player character, points possessed by each character and/or each player may be displayed (when the points possessed by each player are displayed, the points may be displayed at a position where each player's respective player character exists within the play field 300.). Furthermore, the display unit 10 can also display a return instruction area 700 that the player character 400 can be returned to the ally headquarter 302 by costing a prescribed time in response to an instruction of the player received via the input unit 20 regardless of the position of the player character 400 in the play field 300 at a time of the instruction.

Note that in the following description, the illustration and description of the movement instruction input area 212 is omitted to simplify the description.

[Example of Fight Against Neutral Character]

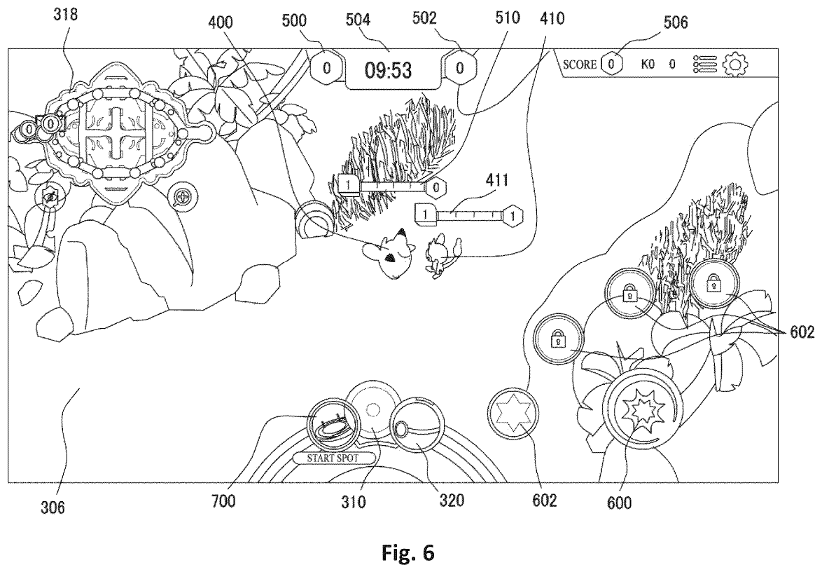

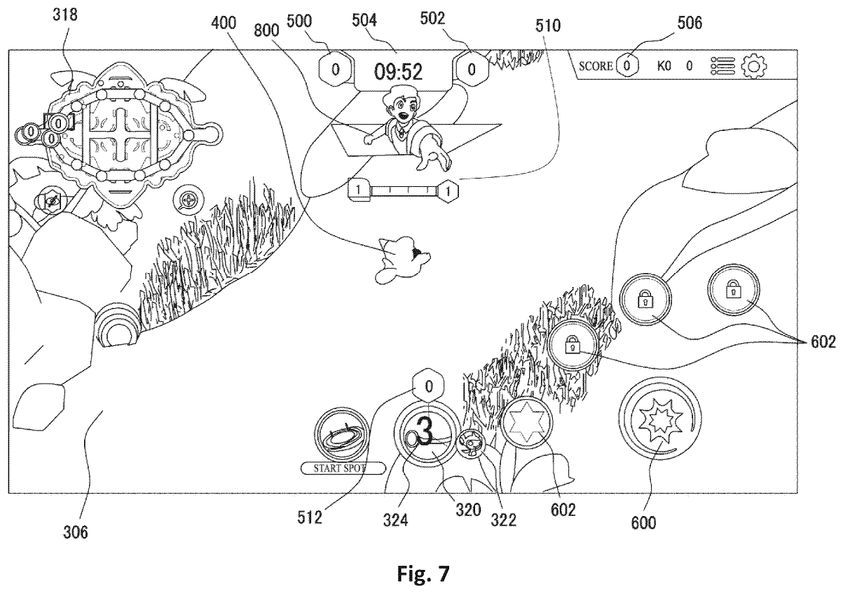

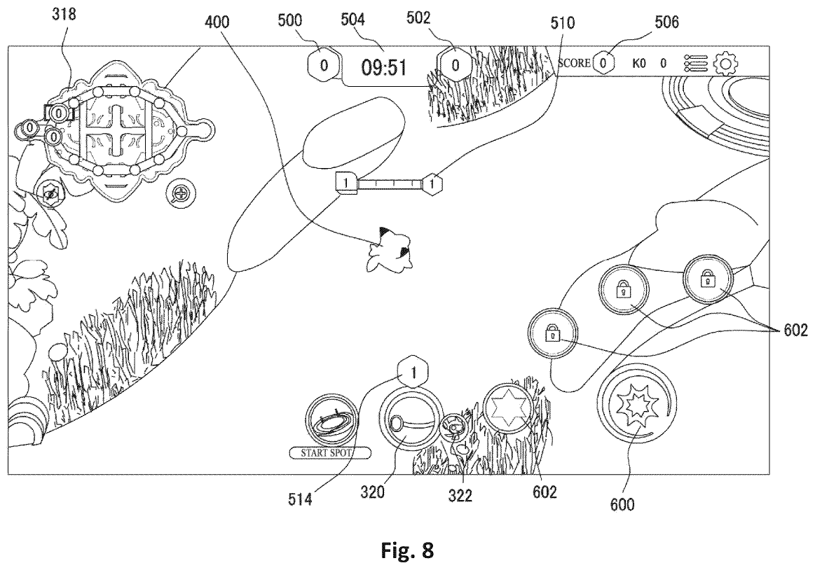

FIG. 6 to FIG. 8 show an outline of fight between the player character and the neutral character in the game system according to the present embodiment. Specifically, FIG. 6 shows an outline of a state at a start of an attack, FIG. 7 shows an outline of a state immediately after victory of the player character 400, and FIG. 8 shows an outline of point display.

For example, as shown in FIG. 6, when a neutral character 410 is within a prescribed range from the player character 400 moving in the lane 306 of the play field 300 in response to operation of the player, the fight control unit 40 enables the player character 400 to attack the neutral character. Then, when receiving an attack instruction to the neutral character 410 from the player via the input unit 20, the fight control unit 40 starts fight between the player character 400 and the neutral character 410. For example, when the input unit 20 receives an instruction for the attack instruction area 600 from the player, the fight control unit 40 causes the player character 400 to perform an attack (for example, a normal attack that can be used by the player character 400 from beginning of the game) on the neutral character 410.

Here, the display unit 10 can display status 510 of the player character 400 in the vicinity of the player character 400 and status 411 of the neutral character 410 in the vicinity of the neutral character 410. The status displays, for example, a level, HP, and possessed points (if the character is a player character, the points owned by the player of the player character) of each character. As an example, the status includes a rectangular portion that indicates the HP by the length of a horizontal bar, a roughly square level display area that displays the level of a character numerically at the left end of the rectangular portion, and a hexagonal point display area that indicates the points possessed by the character at the right end of the rectangular portion. In an example of FIG. 6, the status 510 indicates that the level of the player character 400 is “1”, the HP is full, and the number of the possessed points owned by the player of the player character 400 is zero, and the status 411 indicates that the level of the neutral character 410 is “1”, the HP is full, and the possessed points is “1”.

The fight control unit 40 causes the display unit 10 to display situations (for example, a situation of decrease in the HP, and the like) of the status 510 and the status 411, which change in response to the fight between the player character 400 and the neutral character 410. Then, the fight result determination unit 45 determines that the player character 400 wins against the neutral character 410 when the HP of the neutral character 410 becomes zero due to the attack by the player character 400, for example. Next, the character state decision unit 50 associates the neutral character 410 with the player of the player character 400 based on the determination result of the fight result determination unit 45. As a result, the player acquires the neutral character 410.

As shown in FIG. 7, the character state decision unit 50 is configured to erase the display of the neutral character 410 from the play field 300 and stores the defeated neutral character 410 as an ally character in the character storage area 320 for the player. For example, the display unit 10 displays a ball-shaped character storage area 320 at a prescribed position, and displays the stored character presentation 322 that presents the ally character stored in the character storage area 320 at or near a position in contact with the character storage area 320. In the example of FIGS. 6 and 7, since the neutral character 410 has become an ally character, it can be understood by referring to the stored character presentation 322 that the neutral character 410 is stored as an ally character in the character storage area 320. The stored character presentation 322 presents, for example, an image of the ally character, or the stored character presentation 322 presents the name of the ally character. In this case, for the player to easily understand that the player character 400 has acquired the neutral character 410, the display unit 10 may display a performance display 800 indicating the acquisition of the neutral character and the earning of points/experience value at a prescribed position.

Furthermore, the elapse of a prescribed time may be set as a requisite before the appearance of the ally character from the character storage area 320 to the play field 300 and the storage of the ally character in the character storage area 320 can be repeated by the ally character control unit 55. That is, the ally character may be prohibited from appearing in the play field 300 until the prescribed time elapses after the ally character is stored in the character storage area 320. The display unit 10 may superimpose the lapse of the prescribed time on the character storage area 320 and display the lapse of the prescribed time in a manner that can be perceived by the player. For example, the display unit 10 performs a countdown display 324 for a time until the control of the appearance of the ally character in the play field 300 and the storage in the character storage area 320 by the ally character control unit 55 becomes possible. After the countdown display 324 ends, the ally character control unit 55 enables the ally character stored in the character storage area 320 to appear in the play field 300 in response to an instruction from the player.

Moreover, since the player character 400 has won the neutral character 410, the point giving control unit 62 is configured to give points possessed by the neutral character 410 to the player of the player character 400. In this case, the point giving control unit 62 updates the point display area of the status 510 of the player character 400, and causes the display unit 10 to display that the player of the player character earns the points. In the example of FIG. 7, since the points possessed by the neutral character 410 is “1”, the points earned by the player is also “1”, and since the possessed points of the player before this point is earned is “0”, “1” is displayed in the point display area of the status 510.

Furthermore, the point giving control unit 62 can also display the points earned by the player as the point display 512 in the vicinity of the character storage area 320. However, the point giving control unit 62 displays the point display 512 as the points that the player possesses before defeating the neutral character 410 and earning the points of the neutral character 410, until the prescribed time has elapsed before the appearance of the ally character from the character storage area 320 to the play field 300 and the storage of the ally character in the character storage area 320 can be repeated by the ally character control unit 55. In the example of FIG. 7, since the points possessed by the player is zero before the player character 400 defeats the neutral character 410 (as shown in the status 510 displayed in FIG. 6), the point display 512 is also zero. Note that, when a player had a prescribed number of points before the player character 400 of the player defeats the neutral character 410, the point display 512 displays the prescribed number of points.

Then, when the prescribed time has elapsed before the appearance of the ally character from the character storage area 320 to the play field 300 and the storage of the ally character in the character storage area 320 can be repeated by the ally character control unit 55 (in this case, the above-mentioned countdown display is erased), as shown in FIG. 8, the point giving control unit 62 updates the display of the point display 512 according to the points possessed by the neutral character 410 defeated by the player character 400. That is, in an example of FIG. 8, since the points possessed by the neutral character 410 defeated by the player character 400 is “1” as shown in FIG. 6, the “0” of the point display 512 shown in FIG. 7 is updated to “1” of point display 514 shown in FIG. 8. As a result, “1” is also displayed on the point display 514.

Moreover, since the player character 400 wins the fight against the neutral character 410, the experience value giving unit 60 gives the player character 400 a prescribed experience value. The experience value giving unit 60 displays the level of the player character 400, which is decided according to the cumulative total of the experience values earned by the player character 400, in the level display area of the status 510.

[Example of Fight Together with Ally Character]

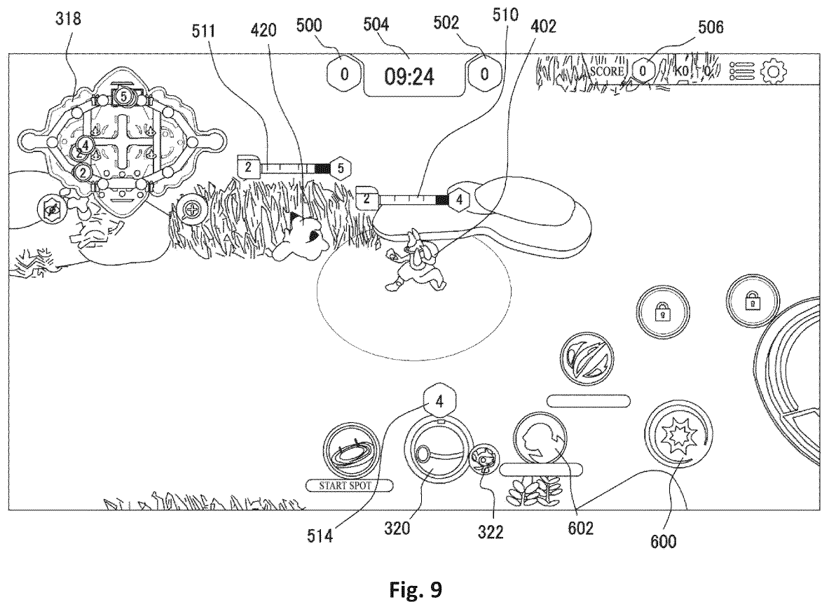

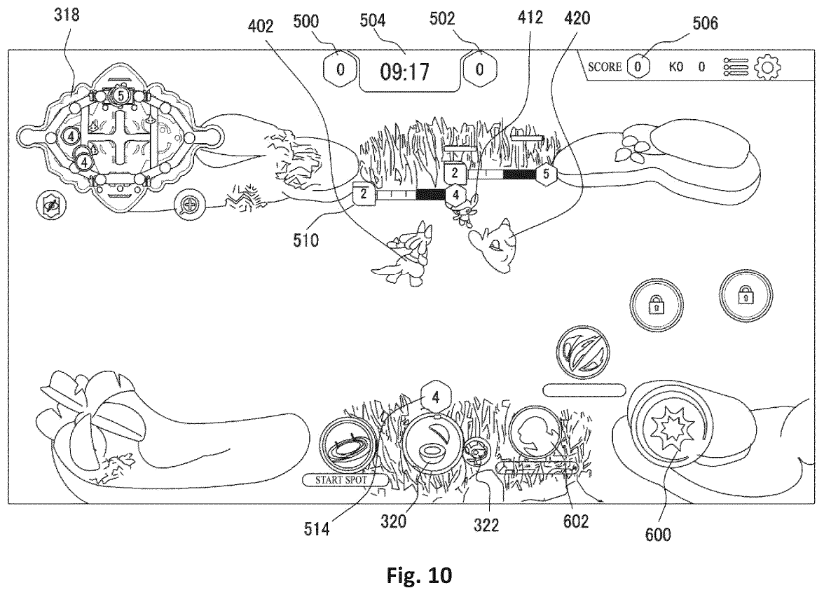

FIGS. 9 and 10 show an outline of how the player character and the ally character fight together in the game system according to the present embodiment. Specifically, FIG. 9 shows an example of a state in which the ally character is stored in the character storage area 320, and FIG. 10 shows an example of a state in which the ally character appears in the play field 300.

First, as shown in FIG. 9, it is assumed that a player character 402 is fighting against an enemy player character 420 while an ally character of the player character 402 is stored in the character storage area 320. Note that the stored character presentation 322 enables understanding of the ally character stored in the character storage area 320. Then, the fight control unit 40 controls the fight between the player character 402 and the enemy player character 420. Furthermore, the fight control unit 40 causes the display unit 10 to display the status 510 of the player character 402 and the status 511 of the enemy player character 420, which change in response to the fight between the player character 402 and the enemy player character 420. Note that the status 510 is displayed in the vicinity of the player character 402, and the status 511 is displayed in the vicinity of the enemy player character 420.

Specifically, when the enemy player character 420 exists within a predetermined range from the player character 402, the fight control unit 40 enables the player character 402 to attack the enemy player character 420. Then, when the fight control unit 40 receives an attack instruction against the enemy player character 420 from the player via the input unit 20, the fight control unit 40 starts fight between the player character 402 and the enemy player character 420. For example, when the input unit 20 receives an instruction of the player to the attack instruction area 600, the fight control unit 40 causes the player character 402 to execute an attack on the enemy player character 420, and when the input unit 20 receives an instruction of the player to the skill generation area 602, the fight control unit 40 causes the player character 402 to execute an attack on the enemy player character 420 by a skill. Note that, when the player causes the player character 402 to perform an attack by a skill via the skill generation area 602, the fight control unit 40 may prohibit the player character 402 from executing the skill again until a prescribed time has elapsed from the execution of the skill.

Next, as shown in FIG. 10, the ally character control unit 55 is configured to cause the ally character 412 stored in the character storage area 320 to appear in the play field 300 based on an instruction from the player that makes the ally character 412 appear in the play field 300. Here, the “ally character stored” refers to the ally character 412 that can appear in the play field 300 at any timing in response to the instruction of the player. Note that the stored character presentation 322 presents the ally character 412 appearing in the play field 300. Specifically, the ally character control unit 55 causes the ally character 412 stored in the character storage area 320 to appear in the play field 300 in response to the instruction of the player (for example, an instruction by the player by tapping the character storage area 320) to the character storage area 320 received via the input unit 20. Then, the ally character control unit 55 controls the appearing ally character 412 to move around the player character 402 so as to automatically follow the player character 402. Further, the ally character control unit 55 automatically executes an attack on the enemy player character 420 existing within a predetermined range from the ally character 412. In the example of FIG. 10, the ally character 412 is controlled by the ally character control unit 55 and executes an attack on the enemy player character 420. The ally character control unit 55 further stores the ally character 412 appearing in the play field 300 in the character storage area 320 in response to a further instruction of the player to the character storage area 320 received via the input unit 20.

When the ally character 412 appears in the play field 300, the ally character control unit 55 can also display a display icon of the character storage area 320 to indicate a situation where the ally character 412 is outside. As an example, under a case where the character storage area 320 is represented by a ball-shaped display icon, a state in which the ball is closed when the ally character is stored is shown as shown in FIG. 9, and a state in which the ball is open when the ally character appears in the play field 300 is shown as shown in FIG. 10.

Then, when the enemy player character 420 is defeated by an attack by the player character 402 and/or the ally character 412, the experience value giving unit 60 gives a prescribed amount of experience value to the player character 402. Here, the ally character control unit 55 erases the ally character 412 from the play field 300 when the ally character 412 is defeated by an attack from the enemy player character 420. As a result, the ally character possessed by the player disappears. Then, the point giving control unit 62 acquires a determination result indicating that the ally character 412 has lost from the ally character control unit 55, and reduces points possessed by the player of the player character by a prescribed amount.

Note that the method for fighting together with the ally character 412 is not limited to the above example, and can be realized by various methods. For example, movement of the ally character 412 and the attack on the enemy player character 420 by the ally character 412 may be executed based on operation instructions of the player, rather than automatically executed. Furthermore, in response to the instruction of the player to the character storage area 320 received via the input unit 20, the ally character 412 may not appear in the play field 300, and a prescribed game effect such as a skill or an item associated with the ally character 412 may be generated in a prescribed range in the play field 300. In this case, the ally character control unit 55 can restrict use of the skill or item associated with the ally character 412 when the player character satisfies a prescribed condition such as being defeated by an attack from the enemy player character 420.

[Example of Scoring Points].

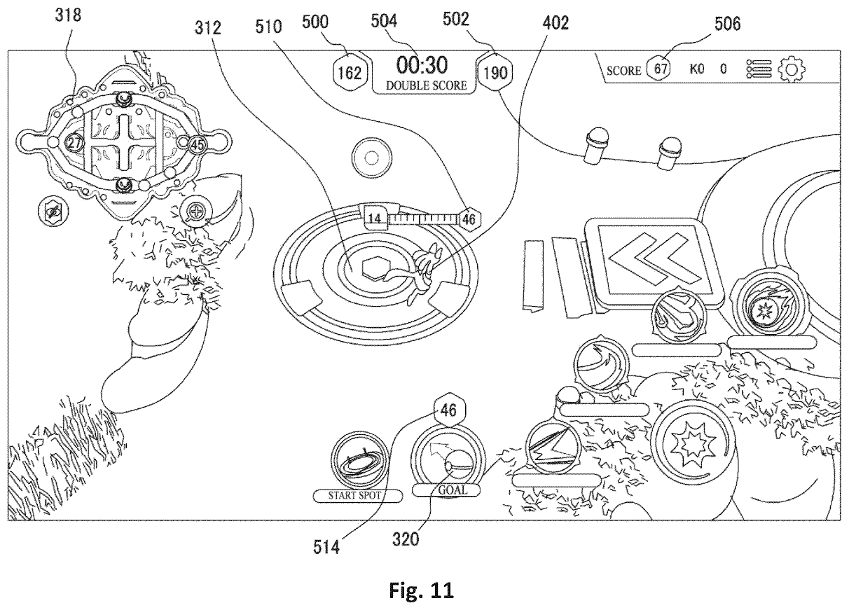

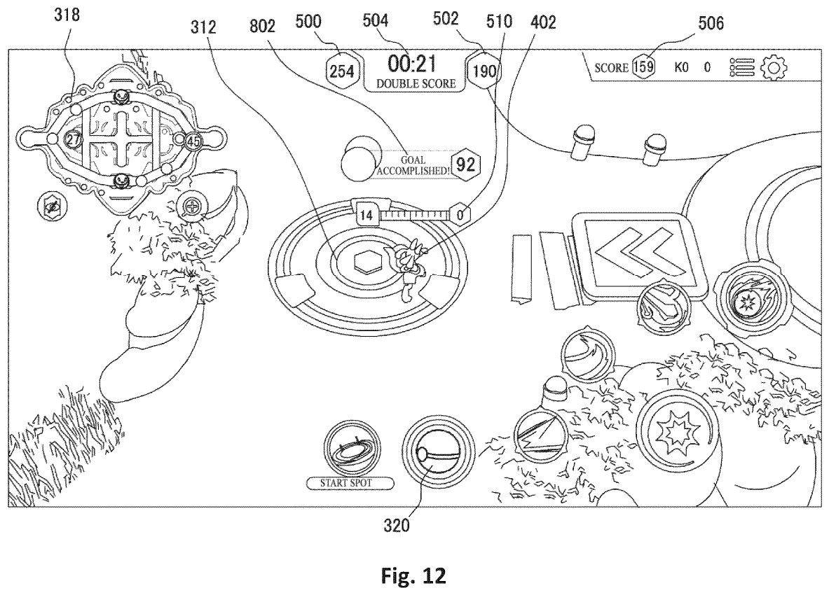

FIGS. 11 and 12 show an outline of an example of point scoring in the game system according to the present embodiment. Specifically, FIG. 11 shows an example of a state before the points possessed by the player character 402 are scored, and FIG. 12 shows an example of a state after the points possessed by the player character 402 are scored.

When the player of the player character 402 possesses points, the scoring unit 70 can score the points as a score of the team to which the player of the player character 402 belongs under a prescribed condition. FIGS. 11 and 12 show an example in which a score is given to a team (ally team) of the player character 402. FIG. 11 shows that the ally team score 500 is “162” and the enemy team score 502 is “190”, and the player score 506 shows that the points earned by the individual player up to a time of the state shown in FIG. 11 is “67”. Furthermore, in FIG. 11, the remaining game time 504 is also displayed (FIG. 11 shows an example in which the remaining time is 30 seconds).

First, as shown in FIG. 11, the player of the player character 402 possesses a prescribed number of points. The points possessed by the player of the player character 402 are displayed in a point display area of the status 510 of the player character 402 and a point display 514 displayed in the vicinity of the character storage area 320 (in the example of FIG. 11, the player of the player character 402 possesses “46” points. Note that, in the example of FIG. 11, the level of the player character 402 is displayed in the level display area and is level “14”).

When the player character 402 enters a prescribed range from the enemy base 312 (hereinafter sometimes referred to as “enemy base area”), the points possessed by the player of the player character 402 are set as the score of the ally team in response to a scoring instruction of the player received via the input unit 20. Specifically, the enemy base 312 has, for example, a substantially circular area. Then, when the player character 402 enters this area, the scoring unit 70 can perform a display indicating that scoring can be done in the character storage area 320. In the example of FIG. 11, an arrow shape is added to the ball shape displayed in the character storage area 320, and a text “goal” is displayed.

Then, when the input unit 20 receives an instruction (for example, a tap operation and a long press operation) from the player to the character storage area 320 in this state, the scoring unit 70 executes a scoring process. Specifically, the scoring unit 70 does not score points until a prescribed time (i.e., a scoreable time set for the enemy base 312) has elapsed from the time when the player gave an instruction for scoring to the character storage area 320 while continuing the instruction, but executes scoring of the points when the scoreable time elapses in a state where the instruction continues. That is, the scoring unit 70 executes a countdown process until scoring. Here, when the player character 402 goes out of the enemy base area or is defeated by the enemy player character 420 before the points are scored, and/or when the instruction of the player is interrupted, the countdown process by the scoring unit 70 may be reset.

Then, when the scoreable time has elapsed, the scoring unit 70 executes a process (scoring process) of making the points possessed by the player of the player character 402 into a score of the ally team. In other words, in a state where the player character enters the enemy base area, the scoring unit 70 starts the measurement of the time from the time when it receives a scoring instruction from the player via the input unit 20, and completes the scoring process at the timing when the scoreable time has elapsed in a state where the scoring instruction continues. In the example of FIG. 12, “46” points the player of the player character 402 has are converted (scored) into a score and added to the score of the ally team. When the points the player of the player character 402 has are scored, the scoring unit 70 sets the points the player of the player character 402 has to zero and displays that fact. For example, the display in the point display area of the status 510 of the player character 402 is set to “0” and the point display 514 displayed near the character storage area 320 is erased.

After scoring the points into a score and adding the score to the score of the ally team, the scoring unit 70 updates and displays the display of the score of the ally team and display of a score of the individual player. The example of FIG. 12 shows that the ally team score 500 is “254” and the player score 506, which is the score of the individual player, is “159”. Furthermore, when the scoring of the points is completed, the scoring unit 70 may display a display 802 indicating that the scoring is successful at a prescribed position of the display unit 10 (for example, a text display such as “Goal Accomplished!” can be displayed).

Note that the scoring unit 70 may add a correction to the score that can be earned by each team when the remaining time of the game becomes equal to or less than a prescribed time. For example, in the example of FIG. 12, the scoring unit 70 sets the score that can be earned by each team to “double” when the remaining time of the game becomes equal to or less than the prescribed time. Therefore, although the points possessed by the player in the example of FIGS. 11 and 12 is “46”, the score of the ally team by scoring is not “208” but “254”, and the score earned by the individual player is not “46” but “92” (so the score of the individual player after scoring becomes to “159”). Therefore, the scoring unit 70 scores the points possessed by the player without correcting the points before the remaining time of the game becomes equal to or less than the prescribed time, and adds the score to the scores of the ally team and the individual player (for example, in the example of FIGS. 11 and 12, when the remaining time of the game is not equal to or less than the prescribed time, the “46” points possessed by the player are scored as a score of “46”, and the score “46” is added to the score “162” of the ally team to obtain a score of “208”, and added to the score “67” of the individual player to obtain a score of “113”).

Furthermore, the scoring unit 70 is configured to supply the supply value corresponding to the score obtained by scoring the points to the enemy base 312. Then, the scoring unit 70 accumulates the supply value in the enemy base 312. The supply value may be the same as a value of the score. The base control unit 80 stops the function of the enemy base 312 when a total value of the supply values accumulated in the enemy base 312 by the scoring unit 70 becomes equal to or more than a predetermined durability value in the enemy base 312. After the function of the enemy base 312 is stopped, points cannot be supplied to the enemy base 312 and scored, and the supply value cannot be accumulated. Therefore, the players of the ally team aims at another enemy base 312, and aims to score the points and accumulate the supply value at the other enemy base 312 or stop the function of the other enemy base 312.

As an example in the present embodiment, a plurality of enemy bases 312 are arranged from a side close to the ally headquarter 302 toward the enemy headquarter 304, and the durability value of the enemy bases 312 can be set higher as the distance from the side close to the ally headquarter 302 increases. That is, the amount of points scored at the enemy base 312 on the side far from the ally headquarter 302 is set larger than the amount of points scored at the enemy base 312 on the side close to the ally headquarter 302. As a result, the player of the ally team aims to improve the level thereof by accumulating the experience value of the player character thereof while executing the game on the side close to the ally headquarter 302 at the start of the game, for scoring more points during the middle of the game to the end of the game, cause the player character to possess more points, and score the points at the enemy bases 312 on the side close to the enemy headquarter 304.

[Example of First Special Character]

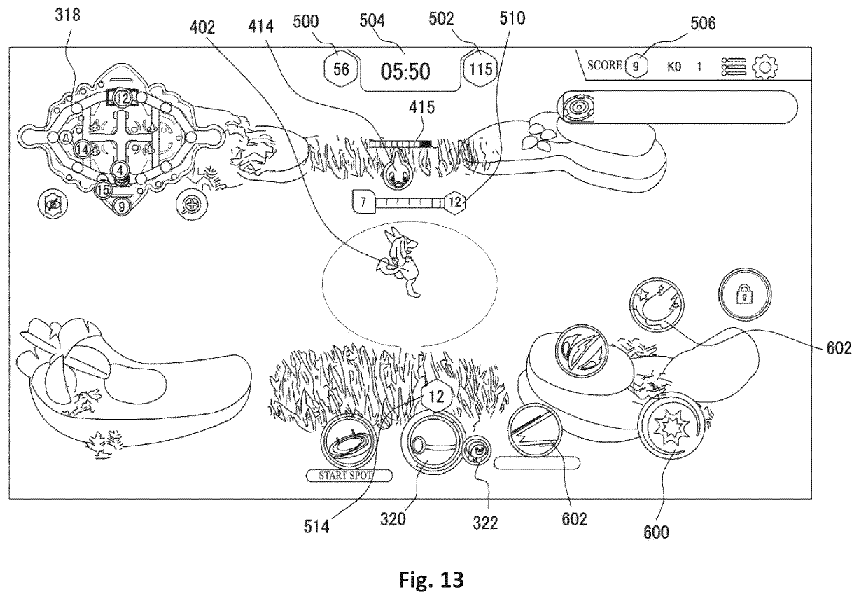

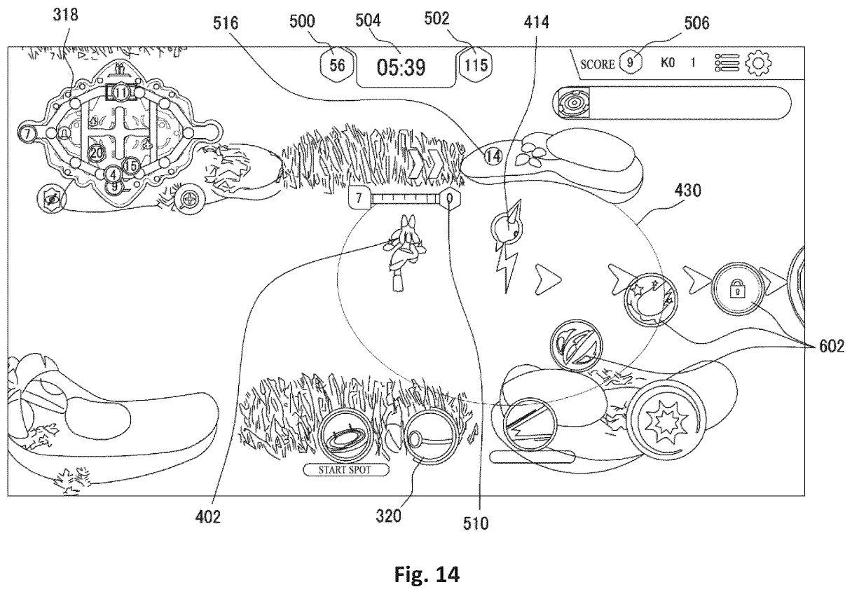

FIG. 13 and FIG. 14 show an outline of an example of the first special character in the game system according to the present embodiment. Specifically, FIG. 13 shows an example of fight between the player character 402 and a first special character 414, and FIG. 14 shows an example in which the first special character 414 belongs to the ally team.

First, the appearance control unit 35 is configured to cause the first special characters 414 to appear at two prescribed positions in the play field 300 at the same time. For example, when the play field 300 is substantially an ellipse and the lanes 306 are provided along the vicinity of an outer circumference of the ellipse, the appearance control unit 35 causes the first special characters 414 to appear near two intersections of a minor axis of the ellipse and the lanes 306, respectively. As a result, chances of encountering the first special characters 414 can be equalized for the ally player characters of the ally team and the enemy player characters of the enemy team.

Then, as shown in FIG. 13, when the first special character 414 exists within a prescribed range from the player character 402 existing in the play field 300 in response to an operation of the player, the fight control unit 40 enables the player character 402 to attack the first special character 414. Then, when the fight control unit 40 receives an attack instruction from the player against the first special character 414 via the input unit 20, the fight control unit 40 starts a fight between the player character 402 and the first special character 414.

The fight control unit 40 is configured to cause the display unit 10 to display situations of the status 510 of the player character 402 and the status 415 of the first special character 414 that change in response to the fight between the player character 402 and the first special character 414 (for example, a situation of HP decrease and the like). Note that the status 415 of the first special character 414 is displayed in the vicinity of the first special character 414. Furthermore, in the example of FIG. 13, the status 510 of the player character 402 indicates that the level of the player character 402 is “7” and that the player of the player character 402 already possesses “12” points (similarly, the point display 514 displayed near the character storage area 320 also indicates that the player of player character possesses “12” points).

Then, when, for example, the HP of the first special character 414 becomes zero due to an attack by the player character 402, the fight result determination unit 45 determines that the player character 402 has won against the first special character 414. Next, the character state decision unit 50 associates this first special character 414 to a team to which the player of the player character 402 belongs (ally team), based on the determination result of the fight result determination unit 45. Specifically, the character ID of the first special character 414 is associated with the team ID or player ID. This means that the first special character 414 belongs to the ally team.

Note that, when the ally player characters of the ally team and the enemy player characters of the enemy team attack the first special character 414 at the same time, and the first special character 414 is defeated, the fight result determination unit 45 may determine the character who made the last attack to make the HP of the first special character 414 zero (that is, a “last hit” character) as the winning character. In this case, the character state determination unit 50 assigns the first special character 414 to the team to which the winning character belongs.

The special character control unit 57 is then configured to cause the first special character 414 to take over the points possessed by the player of the player character 402, as shown in FIG. 14. That is, the special character control unit 57 delivers the points possessed by the player of the player character 402, who is the winning character, to the first special character 414, adds the points to a prescribed number of points uniquely possessed by the first special character 414, and sets the added points as the points possessed by the first special character 414. In the example of FIG. 14, the “12” points possessed by the player of the player character 402 are taken over to the first special character 414, and the first special character 414 has “14” points obtained by adding the “12” points to the “2” points that the first special character 414 possesses in advance. The special character control unit 57 displays the points of the first special character 414 in the vicinity of the first special character 414 (point display 516). Furthermore, when the special character control unit 57 takes over the points possessed by the player of the player character 402 to the first special character 414, the special character control unit 57 sets point display of the status 510 to zero, and erases the point display 514 displayed in the vicinity of the character storage area 320. In this case, the special character control unit 57 also erases the ally character stored in the character storage area 320 and the ally character appearing in the play field from the character storage area 320.

Subsequently, the special character control unit 57 is configured to control the first special character 414 and causes the first special character 414 to advance toward the nearest enemy base 312 closest to the position where the first special character 414 becomes belonging to the ally team. In this case, the special character control unit 57 may increase the movement speed of the first special character 414 when a character of the ally team (a player character and/or an ally character) exists within a prescribed range (hereafter referred to as an “effect range 430”) around the first special character 414. Furthermore, the special character control unit 57 may change the status of the character of the ally team when the character of the ally team exists in the effect range 430. For example, the special character control unit 57 may gradually recover the HP of the character of the ally team within the effect range 430.

Then, when the first special character 414 reaches within a prescribed range from the enemy base 312, the scoring unit 70 automatically scores the points possessed by the first special character 414 into the score of the ally team, supplies the supply value corresponding to the score to the enemy base 312, accumulates the supply values in the enemy base 312, and erases the first special character 414. In this case, the base control unit 80 may invalidate generation of an advantageous effect given to the character of the enemy team (enemy player character and/or ally character of enemy player character) by the enemy base 312 for a certain period of time.

Here, the first special character 414 may be defeated by an attack by the enemy player character and/or the ally character of the enemy player character. Note that the special character control unit 57 may cause the first special character 414 not to attack the enemy player character and/or the ally character of the enemy player character. Then, when the first special character 414 is defeated, the points possessed by the first special character 414 are erased, and the first special character 414 is also erased from the play field 300. Therefore, when the first special character 414 is assigned to the ally team, the player of the ally team has an incentive to operate the player character thereof to protect the first special character 414, and the player of the enemy team has an incentive to operate the player character thereof to attack the first special character 414.

[Example of Second Special Character]

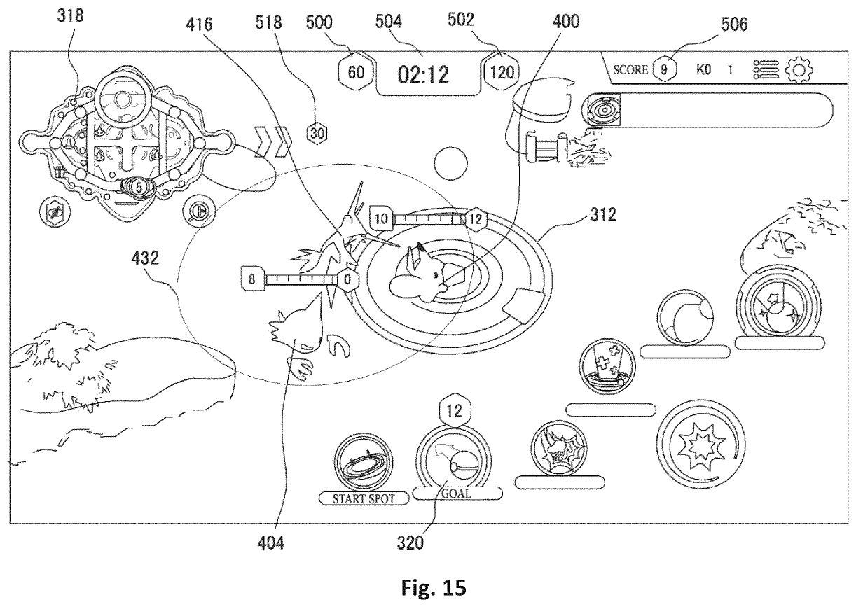

FIG. 15 shows an outline of an example of a second special character in the game system according to the present embodiment.

First, the appearance control unit 35 causes a second special character 416 to appear at a prescribed position in the play field 300. For example, the appearance control unit 35 causes the second special character 416 to appear in the central part 316 of the play field 300. As a result, the ally player character of the ally team and the enemy player character of the enemy team can have an equal chance of encountering the second special character 416. Note that the second special character 416 possesses a prescribed number of points in advance. In the example of FIG. 15, the second special character 416 possesses “30” points.

Then, when the second special character 416 exists within a prescribed range from the player character existing in the play field 300 in response to an operation of the player, the fight control unit 40 enables the player character to attack the second special character 416. Then, when the fight control unit 40 receives an attack instruction from the player against the second special character 416 via the input unit 20, the fight control unit 40 starts a fight between the player character and the second special character 416. The fight control unit 40 causes the display unit 10 to display situations of the status of the player character and the status of the second special character 416 in the same manner as in the fight between the player character 402 and the first special character 414.

Then, when the HP of the second special character 416 becomes zero due to the attack by the player character (for example, the player character 400), the fight result determination unit 45 determines that the player character 400 wins against the second special character 416. Next, the character state determination unit 50 associates the second special character 416 with the team (ally team) to which the player of the player character 400 belongs, based on the determination result of the fight result determination unit 45. As a result, the second special character 416 belongs to the ally team. As for the second special character 416, the character that performs the “last hit” may also be determined as the winning character, as in the case of the first special character 414. The character state determination unit 50 assigns the second special character 416 to the team to which the winning character belongs. Then, as shown in FIG. 15, the special character control unit 57 displays points given to the second special character 416 in advance in the vicinity of the second special character 416 (point display 518).

Subsequently, the special character control unit 57 is configured to control the second special character 416 and advances the second special character 416 toward the enemy base 312 closest to a position where the second special character 416 becomes belonging to the ally team. In this case, the special character control unit 57 may increase the movement speed of the second special character 416 when a character of the ally team (a player character and/or an ally character) exists within a prescribed range (hereafter referred to as an “effect range 432”) around the second special character 416. Furthermore, the special character control unit 57 may change the status of the character of the ally team when the character of the ally team exists in the effect range 432. For example, the special character control unit 57 may gradually recover the HP of the character of the ally team within the effect range 432. In the example of FIG. 15, the player character 400 and a player character 404 belonging to the ally team exist within the effect range 432, and an advantageous effect is generated for these player characters. Note that a character of a type different from the second special character 416 can be another special character, or the like. In this case, the special character control unit 57 may generate a different advantageous effect on the character of the ally team existing in the effect range 432 depending on the type of the special character.

Then, when the second special character 416 reaches a prescribed range from the enemy base 312, according to the lapse of time, the scoring unit 70 automatically scores the points possessed by the second special character 416 into the score of the ally team, supplies the supply value corresponding to the score to the enemy base 312, and accumulates the supply values in the enemy base 312. That is, the scoring unit 70 scores a predetermined amount of the points possessed by the second special character 416 for each predetermined time lapse, and uses the score as the supply value to be supplied to the enemy base 312 (for example, one point per second is scored and used as the supply value). When the special character control unit 57 scores all the points possessed by the second special character 416, the special character control unit 57 erases the second special character 416 from the play field 300.

Here, a case where the supply value corresponding to the points possessed by the second special character 416 is accumulated in the enemy base 312 and a total value of the accumulated supply value becomes equal to or higher than the durability value of the enemy base 312, and the points possessed by the second special character 416 remain will be described. In this case, the base control unit 80 first stops the function of this enemy base 312. Then, the special character control unit 57 causes the second special character 416 to advance toward another enemy base 312 closest to the enemy base 312 whose function is stopped, and controls the second special character 416 in the same manner as described above. That is, when the points possessed by the second special character 416 are given to the enemy base 312 as a supply value, the total value of the supply value reaches the durability value, and the enemy base 312 is destroyed, the special character control unit 57 causes the second special character 416 to advance toward the next enemy base 312 when remaining points possessed by the second special character 416 exist. The special character control unit 57 executes the same process until the points possessed by the second special character 416 become zero.

Here, the second special character 416 may be defeated by an attack by the enemy player character and/or the ally character of the enemy player character. Note that the special character control unit 57 may cause the second special character 416 to move and attack on the enemy player character and/or the ally character of the enemy player character. Then, when the second special character 416 is defeated, the points possessed by the second special character 416 are erased, and the second special character 416 is also erased from the play field 300. Therefore, when the second special character 416 is assigned to the ally team, the player of the ally team has an incentive to operate the player character thereof to protect the second special character 416, and the player of the enemy team has an incentive to operate the player character thereof to attack on the second special character 416.

[Example of Third Special Character]

First, the appearance control unit 35 is configured to cause a third special character to appear at a prescribed position in the play field 300. Note that the third special character has points that are close to the upper limit of the cumulative total of points set for a player, points equal to or greater than the upper limit, or points exceeding the upper limit. Then, when the third special character exists within a prescribed range from a player character existing in the play field 300 in accordance with the player's operation, the fight control unit 40 enables an attack on the third special character by the player character. Then, when the fight control unit 40 receives an attack instruction from the player against the third special character via the input unit 20, the fight control unit 40 starts a fight between the player character and the third special character. The fight control unit 40 causes the display unit 10 to display situations of the status of the player character and the status of the third special character in the same manner as in the fight between the player character 402 and the first special character 414.

Then, when the HP of the third special character becomes zero due to an attack by the player character, the fight result determination unit 45 determines that the player character has won against the third special character. The character state decision unit 50 erases this third special character from the play field 300 based on the determination result of the fight result determination unit 45. As for the third special character, the character that performs the “last hit” may also be determined as the winning character, as in the case of the first special character. Then, the point giving control unit 62 gives the points previously given to the third special character to the player who wins against the third special character, based on the determination result of the fight result determination unit 45. Specifically, the point giving control unit 62 gives some or all of the points of the third special character to the player of the player character. In this case, the point giving control unit 62 causes a point object to appear in the play field 300 when the second condition is satisfied.

Here, a large number of points (e.g., 50 points and 100 points) are associated with the third special character. When the cumulative total of the prescribed points that are given to the player satisfies the first condition set for the player, the point giving control unit 62 automatically gives the points associated with the neutral character to the player, but the third special character is associated with points that are close to the upper limit of the cumulative total of points set for the player, points equal to or greater than the upper limit, or points exceeding the upper limit. Therefore, the point giving control unit 62 confirms that the cumulative total of the prescribed points that are given to the player satisfies the second condition set for the player, and causes a point object corresponding to a prescribed number of points to appear in the play field 300. This makes it easier for the player to have an incentive to fight together with a player character of another player of the team to which he/she belongs when trying to fight against the third special character.

Moreover, when the determination result of the fight result determination unit 45 indicates the win of the player character, the base control unit 80 changes some or all of functions (e.g., defense power and scoreable time) of the enemy base 312 belonging to a different team (enemy team) from the team to which the player character belongs. Specifically, the base control unit 80 changes the parameter about the scoreable time set for some or all of the enemy bases 312 for a predetermined time. For example, the base control unit 80 decreases (e.g., changes to “zero”) the length of the scoreable time set for some or all of the enemy bases 312. As an example, when the length of the scoreable time changes to “zero”, a player belonging to the ally team can cause his/her own player character to invade the enemy base area of the enemy base 312 and score points he/she has at the timing when he/she releases a score instruction via the input unit 20. In other words, since the length of the scoreable time is “zero”, the player on the ally team can score points he/she has by simply tapping without having to perform a long-press operation.

[Example of Fourth Special Character]

An example of a fourth special character will be further described. The appearance control unit 35 causes a fourth special character to appear at a prescribed position in the play field 300. Note that the fourth special character has prescribed points. Then, when the fourth special character exists within a prescribed range from a player character existing in the play field 300 in accordance with the player's operation, the fight control unit 40 enables an attack on the fourth special character by the player character. Then, when an attack instruction from the player for the fourth special character is received via the input unit 20, the fight control unit 40 starts a fight between the player character and the fourth special character. The fight control unit 40 causes the display unit 10 to display situations of the status of the player character and the status of the fourth special character in the same manner as in the fight between the player character 402 and the first special character 414.

Then, when the HP of the fourth special character becomes zero due to an attack by the player character, the fight result determination unit 45 determines that the player character has won against the fourth special character. As for the fourth special character, the character that performs the “last hit” may also be determined as the winning character, as in the case of the first special character. Next, the character state decision unit 50 associates the fourth special character with a team (ally team) to which the player of the player character belongs, based on the determination result of the fight result determination unit 45. Subsequently, the special character control unit 57 controls the fourth special character to advance toward the enemy base 312 closest to a position where the fourth special character becomes belonging to the ally team. Then, when the fourth special character reaches within a prescribed range from the enemy base 312, the base control unit 80 changes some or all of functions of the enemy base 312 (e.g., defense power and scoreable time). Specifically, the base control unit 80 changes the parameter about the scoreable time set for some or all of the enemy bases 312 for a predetermined time. For example, the base control unit 80 decreases (e.g., changes to “zero”) the length of the scoreable time set for some or all of the enemy bases 312.

[Example of Restriction Generation Unit]

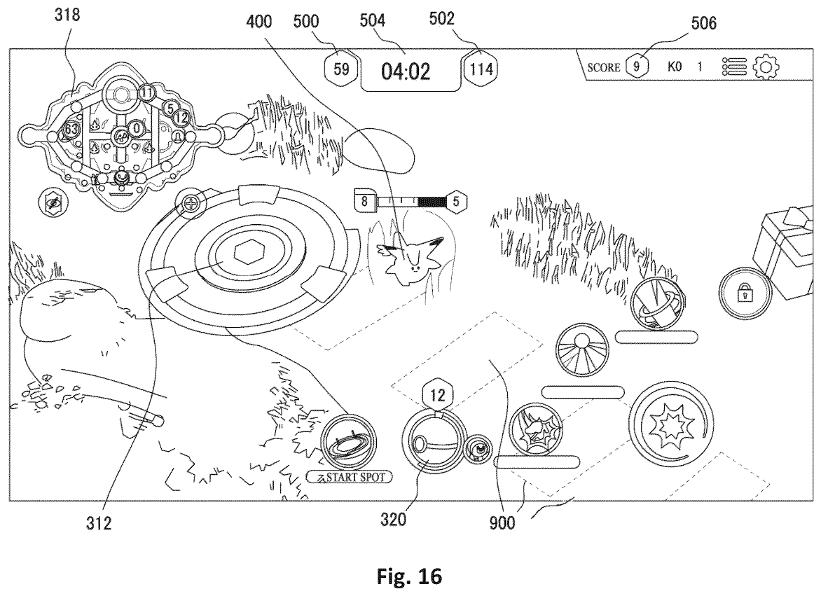

FIG. 16 shows an outline of the function of the restriction generation unit in the game system according to the present embodiment. The example of FIG. 16 shows how the player character 400 of the ally team goes beyond the enemy base 312 whose function is not stopped and advances toward the enemy base 312 next to the enemy base 312 provided along the lane 306.

The restriction generation unit 87 is configured to slow down the movement speed of the player character 400 when the player character 400 invades between one enemy base 312 and another enemy base 312 next to the one enemy base 312. The restriction generation unit 87 causes the display unit 10 to display a restriction area 900, which is an area in which the movement speed of the player character of the ally team is limited. The restriction area 900 is an area where movement is limited in the lane 306 between the one enemy base 312 and the other enemy base 312 next to the one enemy base 312, and is displayed so as to be perceptible by the player. The restriction area 900 is a pattern superimposed and displayed on the lane 306 as an example. The restriction generation unit 87 can also add a prescribed color to the pattern, make the pattern blinking, or the like. Furthermore, the restriction generation unit 87 may display a prescribed pattern around the player character 400 existing in the restriction area 900. Note that, in the example of FIG. 16, a plurality of areas are indicated by dotted lines, but a combination of the plurality of areas shown by the dotted lines and areas between the areas is the restriction area 900 (that is, the entire lane 306 between the one enemy base 312 and the other adjacent enemy base 312 is the restriction area 900).

Furthermore, when the restriction generation unit 87 is configured to apply the movement speed restriction between the one enemy base 312 and the other enemy base 312 located next to the one enemy base 312, the movement speed restriction is released and the display of the restriction area 900 is erased when the function of the one enemy base 312 is stopped by the base control unit 80. Accordingly, the player character of the ally team can move at a normal speed.

[Example of Appearance of Neutral Character Depending on Fight Situation]

The appearance control unit 35 may change the appearance timing and/or the appearance place of a prescribed neutral character in the play field 300 according to fight situation between the ally team and the enemy team. For example, examples of the prescribed neutral character include a neutral character, when being defeated, having an effect of reducing a score of the opponent team that is hostile to the team to which the player character who defeated the prescribed neutral character belongs. Note that the prescribed neutral character may possess a prescribed number of points like other neutral characters, and the prescribed number of points may be given to the player of the player character who defeated the prescribed neutral character.

Specifically, the appearance control unit 35 is configured to change the appearance place of the prescribed neutral character according to a difference between the score of the ally team and the score of the enemy team (hereinafter referred to as a “score difference”). For example, if the score difference is positive (that is, the score of the ally team is more than that of the enemy team), the appearance control unit 35 shifts the appearance place of the prescribed neutral character toward the ally headquarter 302 by a prescribed distance, and if the score difference is negative, the appearance control unit 35 can shift the appearance place of the prescribed neutral character toward the enemy headquarter 304 by a prescribed distance.

First, if no score difference exists between the score of the ally team and the score of the enemy team, the appearance control unit 35 causes the prescribed neutral character to appear at an intermediate point between the ally headquarter 302 and the enemy headquarter 304. However, when the score difference is equal to or less than a prescribed value (for example, when the score of the ally team is “10” and the score of the enemy team is “1”), the appearance control unit 35 shifts the appearance place of the prescribed neutral character toward the ally headquarter 302 by a distance according to the score difference (for example, the appearance place is shifted to the ally headquarter 302 side by a distance of 10% of the straight line distance from the ally headquarter 302 to the enemy headquarter 304). Furthermore, when the score difference exceeds a prescribed value (for example, when the score of the ally team is “90” and the score of the enemy team is “10”), the appearance control unit 35 shifts the appearance place of the prescribed neutral character toward the ally headquarter 302 by a distance according to the score difference (for example, the appearance place is shifted to the ally headquarter 302 side by a distance of 90% of the straight line distance from the ally headquarter 302 to the enemy headquarter 304). That is, the appearance control unit 35 can increase the distance by which the appearance place is shifted as the score difference increases. As a result, the players belonging to the team with the smaller number of score earned can increase chance of defeating the prescribed neutral character by using their own player characters on the side close to the base of the opponent team and chance of quickly scoring the points (that is, a time for the player character of the player possessing the points to reach the base of the opponent team and score the points can be shortened).

[Example of Appearance of Point Object]

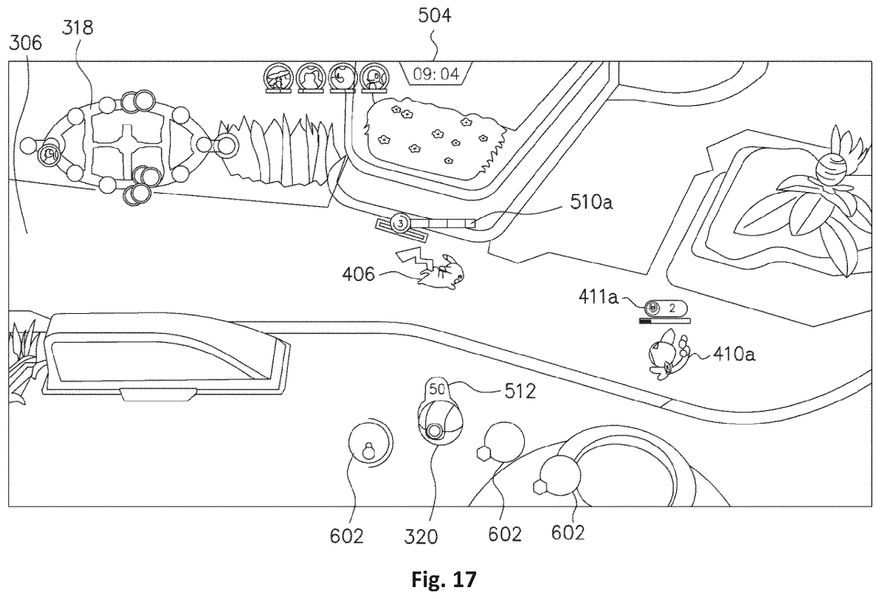

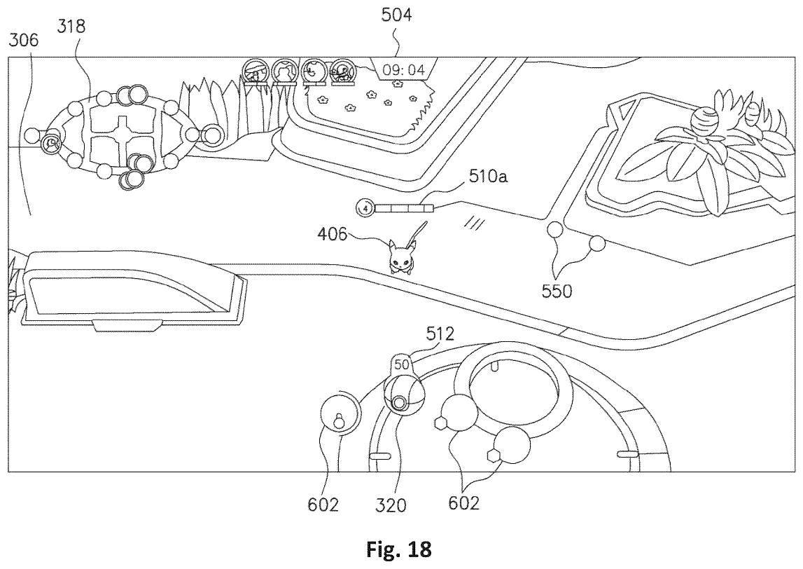

FIG. 17 and FIG. 18 show an outline of the appearance of a point object in the game system according to the present embodiment.

First, as shown in FIG. 17, when a neutral character 410a exists within a prescribed range from a player character 406 moving in a lane 306 of the play field 300 in accordance with the players operation, the fight control unit 40 enables an attack on the neutral character by the player character 406. Then, when an attack instruction from the player for the neutral character 410a is received via the input unit 20, the fight control unit 40 starts a fight between the player character 406 and the neutral character 410a.

Here, the display unit 10 is configured to display a status 510a of the player character 406 in the vicinity of the player character 406 (typically displays it above the player character 406) and displays a status 411a of the neutral character 410a in the vicinity of the neutral character 410 (typically displays it above the neutral character 410a). The status displays, for example, each character's level, HP, and/or the owned points, or the like. This is similar to the description in FIG. 6. In the example of FIG. 17, the status 510a indicates that the level of the player character 406 is “3” and the HP is full, and the status 411a indicates that the neutral character 410a has one HP remaining and “2” points owned. Furthermore, the display unit 10 displays a point display 512, which indicates the points possessed by the player of the player character 406 in real time, at the top of the character storage area 320. In the example of FIG. 17, it is shown that the player of the player character 406 has a total of 50 points. Here, the player of the player character 406 has an upper limit to the number of points he/she can possess, and in the example of FIG. 17, the upper limit is assumed to be “50” points. In other words, in the example of FIG. 17, the player of the player character 406 possesses points up to the upper limit.

Then, the fight control unit 40 is configured to cause the display unit 10 to display situations of the status 510a and the status 411a, which change in response to the fight between the player character 406 and the neutral character 410a. For example, when the HP of the neutral character 410a becomes zero due to the attack by the player character 406, the fight result determination unit 45 determines that the player character 406 wins against the neutral character 410a. Next, the character state decision unit 50 erases the display of this neutral character 410a in the play field 300 based on the determination result of the fight result determination unit 45. For example, the character state decision unit 50 erases the display of the neutral character 410a from the play field 300 after showing the neutral character 410a being stored in the character storage area 320. Then, the point giving control unit 62 gives the points possessed by the neutral character 410a to the player of the player character 406.

That is, since the player character 406 has won against the neutral character 410a, the point giving control unit 62 gives the points possessed by the neutral character 410a to the player of the player character 406. In this case, it is assumed that the player of the player character 406 already has points up to the upper limit of the points that can be possessed. In this case, the point giving control unit 62 converts the points possessed by the neutral character 410a into point objects.

For example, as shown in FIG. 18, the point giving control unit 62 generates point objects 550 corresponding to the surplus points (2 points in the example of FIG. 17) obtained by subtracting the upper limit (50 points in the example of FIG. 17) from the cumulative total of the points that are given to the player of the player character (52 points in the example of FIG. 17), and makes them appear in the play field. In the example of FIG. 18, the point giving control unit 62 generates one point object 550 per point and makes it appear near the location where the neutral character 410a existed in the play field (near the location where the neutral character 410a was defeated by the player character 406). The point objects 550 can be acquired by the player of the player character 406 when the points possessed by the player himself/herself are scored and the possessed points are less than the upper limit, and/or can be acquired by other player characters of other players (player characters of the ally team and/or player characters of the enemy team) whose points have not reached the upper limit. The point giving control unit 62 gives the point corresponding to the point object 550 to a player of a player character who has acquired the point object 550.

Note that, when the points possessed by a player of a player character reaches the upper limit set for the player, the point giving control unit 62 will prohibit the player character of the player from acquiring the point object, regardless of whether the player belongs to the ally team or the enemy team. However, when the player character has scored his/her points in the enemy base 312, and/or when his/her points have decreased due to defeat, etc. in a fight against a neutral character, a special character, or an enemy player character, the points possessed by the player character will fall below the upper limit. In this case, the point giving control unit 62 may allow the player character to acquire point objects that appear in the play field 300 as a result of winning the fight between the player character and a neutral character or the like.

Also, a case will be described in which the neutral character is a prescribed special character and the special character is defeated by an attack from the player character 406 or the like. Note that it is assumed that a large number of points (e.g., 100 points) are associated with this special character. In this case, the point giving control unit 62 may make some or all of the points associated with the special character appear in the play field as one or more point objects regardless of whether or not the points possessed by the player of the player character who defeated the special character reach the upper limit set for the player of the player character.

Here, when a player operates his/her own player character to fight against a special character to which a large number of points are associated, if the player wins the fight using only his/her own player character, it is expected that the upper limit of points that can be possessed, which is set for the player may easily be exceeded early. Here, it is assumed that the special character to which a large number of points are associated is set to be less likely to be defeated in the fight than other neutral characters. Therefore, it is easier to defeat the special character by fighting together with other player characters of the ally team than only by one's own player character. Furthermore, it is strategically possible for the player characters of the players on the ally team to share and acquire the large number of points associated with the special character when the special character is defeated. This provides an incentive for a plurality of player characters to fight against the special character together.

The point giving control unit 62 is also configured to control the method of acquiring the point object. Specifically, when the positional relationship between a player character and the point object satisfies a prescribed condition, the point giving control unit 62 causes the player character to acquire the point object. Then, the point giving control unit 62 gives the point corresponding to the point object to the player of the player character that has acquired the point object. For example, when the player character contacts the point object and/or when the player character collides with the point object, the point giving control unit 62 causes the player character to acquire the point object. Note that the point giving control unit 62 may, based on a prescribed operation of the player that is received via the input unit 20, cause the player character of the player to acquire the point object. For example, when a player taps an area on the display unit 10 where a point object is displayed, the player character of the player may be allowed to acquire the point object. The point giving control unit 62 may also change the method of acquiring the point object depending on the type of the player character. For example, in the case of a prescribed player character, if the distance between the player character and the point object is equal to or less than a certain distance, the player character may be allowed to acquire the point object without contacting the point object.

Note that even when the positional relationship between the player character and the point object satisfies a prescribed condition or when the player has given an instruction for acquiring the point object, the point giving control unit 62 can, if the cumulative total of the points possessed by the player of the player character satisfies the second condition, prohibit the acquisition of the point object by the player character.

Furthermore, point objects that appear when a player character defeats a neutral character may be associated with a team ID of a team to which the player character belongs. Then, when another player character on the ally team acquires the point object, the point corresponding to the point object is given to this another player character, and information indicating that the point was earned by the player characters “assist” to the ally team may be associated with this another player character. That is, the game system 1 may separately manage point objects that appear based on behaviors of a player character and point objects that appear based on behaviors of another player character, or may manage them without distinguishing between them. In the case where they are managed separately, the game system 1 may display the results of assists of each player character along with the results of each player character when displaying the game results on the display unit 10 after the fight ends.

Moreover, since the player character 406 wins the fight against the neutral character 410a, the experience value giving unit 60 gives a prescribed experience value to the player character 406. The experience value giving unit 60 displays the level of the player character 406, which is decided in accordance with the accumulated total of experience values earned by the player character 406, in the level display area of the status 510a. In the examples of FIGS. 17 and 18, it is shown that the level of the player character 406 has increased from “3” to “4”.

Note that, in order to make it easier for the player to understand that the player character 406 has won against the neutral character 410a and/or has earned points, the display unit 10 may display a performance display indicating the acquisition of the neutral character and the acquisition of points/experience value at a prescribed position.

[Modified Example]

In the game system 1 according to the present embodiment, when the player character defeats the neutral character, the player character earns the points possessed by the neutral character. However, in this modified example, the neutral character may have a prescribed item. In this case, when the player character defeats the neutral character, the player character acquires the prescribed item. Then, the player character may provide the prescribed item to the base of the opponent to give a score to the team to which the player character belongs based on the provided item.

[Flow of Process of Game System 1]

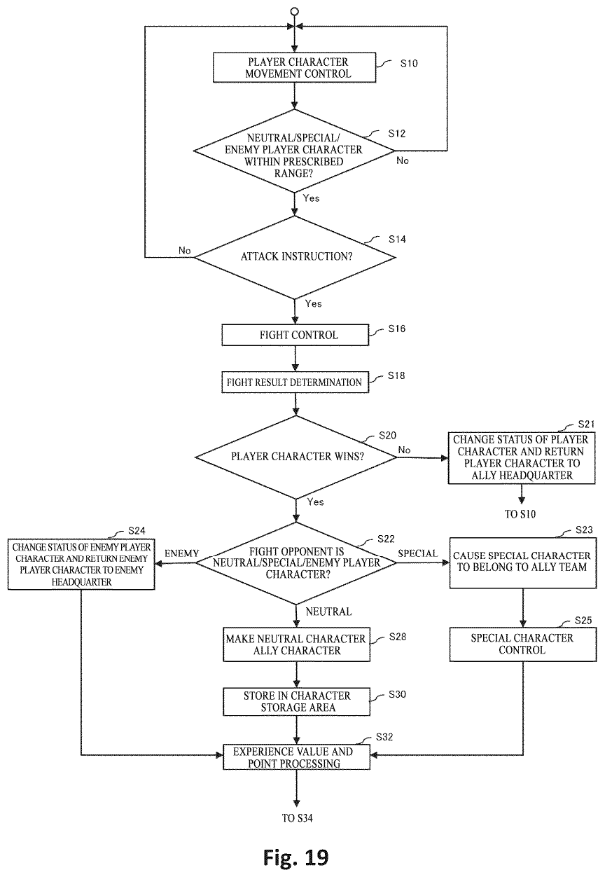

FIGS. 19 to 22 show an example of a processing flow in the game system according to the present embodiment.

First, at the start of the game of the game system 1, one or more players belonging to one team (ally team) select their own player characters (ally player characters), and one or more other players belonging to the other team (enemy team) also select their own player characters (enemy player characters). In the following, the description takes one player of the ally team as a subject.

As shown in FIG. 19, after the game starts, the character action control unit 30 controls the movement of the player character of the player in the play field 300 in response to an instruction of the player received via the input unit 20 (step 10; hereinafter, a step is referred to as “S”). As a result, the player character moves in the lanes 306, the neutral region 314, the central part 316, and the like of the play field 300. Then, when a neutral character, a special character, or an enemy player character (hereinafter referred to as a “target character”) exists in a virtual circular area (hereinafter referred to as “attackable range”) having a prescribed radius around the player character (Yes in S12), the character action control unit 30 executes movement control of the player character, and the fight control unit 40 judges whether or not an attack instruction from the player is received via the input unit 20 (S14). On the other hand, when no target characters exist within the attackable range (No of S12), the character action control unit 30 continues controlling the movement of the player character (S10). If the fight control unit 40 does not receive the attack instruction from the player via the input unit 20 (No in S14), the character action control unit 30 also continues controlling the movement of the player character (S10).

When the fight control unit 40 receives the attack instruction from the player via the input unit 20 (Yes in S14), the fight control unit 40 is configured to control the fight between the player character and the target character within the attackable range (S16). The fight control unit 40 supplies information indicating changes in status of both characters caused by the fight between the player character and the target character to the fight result determination unit 45. The fight result determination unit 45 determines which of the two characters wins based on the information received from the fight control unit 40 (S18). When the fight result determination unit 45 determines that the player character wins against the target character (Yes in S20), a process is executed according to the type of the target character (S22).

(When the Player Character has Won Against the Target Character)

First, when the target character is a neutral character (“neutral” in S22), the character state decision unit 50 makes the neutral character an ally character of the player character by associating the neutral character with the player (S28). That is, the character state decision unit 50 associates the character ID of the neutral character with the player ID. Then, the character state decision unit 50 erases display of the neutral character from the play field 300, and stores the neutral character as an ally character in the character storage area (S30). In this case, an image of the stored ally character (that is, an icon) is displayed in contact with or in the vicinity of the character storage area. Furthermore, the experience value giving unit 60 gives a prescribed experience value to the player character based on defeating the neutral character, and the point giving control unit 62 gives the player points previously associated with the neutral character (S32).

Moreover, when the target character is an enemy player character (“enemy” in S22), the character state decision unit 50 changes the status of the enemy player character (for example, the HP, which became zero when losing to the player character, is fully recovered costing a prescribed period of time) and returns the enemy player character to the enemy headquarter 304 (S24). Note that the character state decision unit 50 prohibits operations on the enemy player character from a time when the enemy player character loses until the enemy player character is returned to the enemy headquarter 304. Then, the experience value giving unit 60 gives the player character a prescribed experience value based on defeating the enemy player character, and the point giving control unit 62 gives a prescribed number of points to the player based on defeating the enemy player character (S32).

Furthermore, when the target character is a special character (“special” in S22), the character state decision unit 50 assigns the special character to the team to which the player belongs (S23). That is, the character state determination unit 50 associates the character ID of the special character with the team ID of the ally team. Unlike the neutral character, the character state decision unit 50 does not store the special character in the character storage area and keeps the special character appearing in the play field 300. Then, the special character control unit 57 controls the special character and causes the special character to perform a prescribed action according to the type of the special character (S25). Furthermore, the experience value giving unit 60 gives a prescribed experience value to the player character based on defeating the special character. Note that the point giving control unit 62 may not give the prescribed number of points to the player based on defeating the special player character (S32).

(When the Player Character has Lost to the Target Character)

However, when the player character loses fight against the target character (No in S20), the character state decision unit 50 changes the status of the player character (for example, the HP, which became zero when losing to the target character, is fully recovered costing a prescribed period of time) and returns the player character to the ally headquarter 302. Note that the character state decision unit 50 prohibits operations on the player character from a time when the player character loses until the player character is returned to the ally headquarter 302. After the player character returns to the ally headquarter 302, steps from S10 are executed again.

(Control of Ally Character)

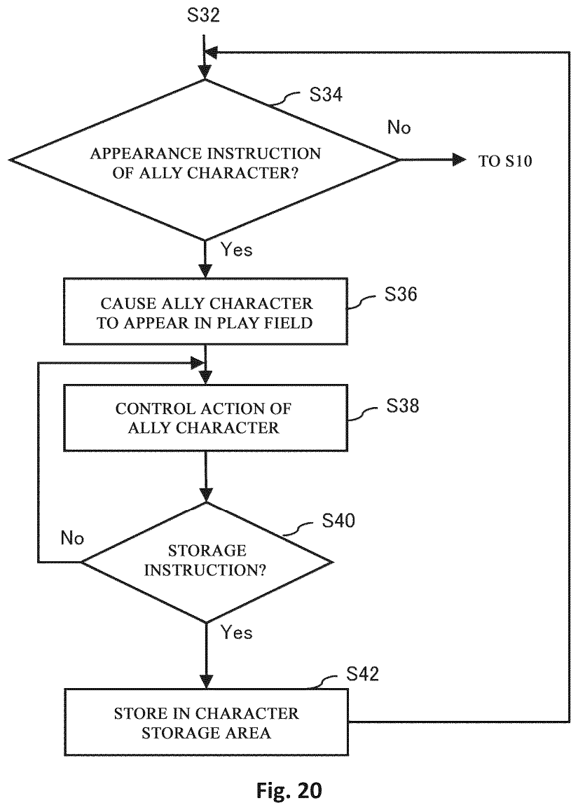

Next. FIG. 20 shows a control flow of the ally character. First, with the ally character stored in the character storage area, the ally character control unit 55 judges whether or not an appearance instruction from the player for the ally character to appear in the play field 300 is received via the input unit 20 (S34). If no appearance instruction is received (No in S34), steps from S10 are executed. However, when an appearance instruction is received (Yes in S34), the ally character control unit 55 causes the ally character to appear in the play field 300 from the character storage area (S36). Here, the character storage area can be displayed having, for example, a ball shape. A closed ball is displayed when the ally character is stored, and an open ball is displayed when the ally character is released out.

Then, the ally character control unit 55 is configured to control action of the ally character appearing in the play field 300 (S38). Specifically, the ally character control unit 55 moves the ally character so as to follow the player character. When an enemy player character, another neutral character, and/or a special character exists within a prescribed range from the player character or the ally character, the ally character control unit 55 causes the ally character to automatically perform an attack on the enemy player character, the other neutral character, and/or the special character.

Subsequently, the ally character control unit 55 is configured to store the ally character appearing in the play field 300 in the character storage area, and erases the display of the ally character from the play field 300 (S42) when a storage instruction from the player to the character storage area of the ally character is received via the input unit 20 (Yes in S40). Then, S34 and steps thereafter are executed. On the other hand, when the ally character control unit 55 does not receive the storage instruction from the player to the character storage area of the ally character via the input unit 20 (No in S40), S38 and steps thereafter are executed.

(Control Performed when a New Neutral Character is Acquired)

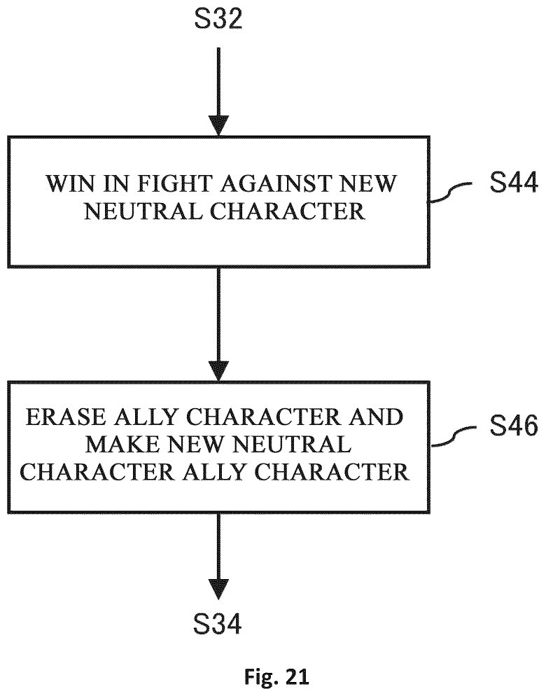

Furthermore, FIG. 21 shows a control flow when the player character fights against a new neutral character. When the player character possesses an ally character, if the player character fights and wins against a new neutral character (S44), the character state decision unit 50 makes the new neutral character a new ally character (S46). Then, the character state decision unit 50 erases the ally character stored in the character storage area or the ally character appearing in the play field 300, and stores the new neutral character as an ally character in the character storage area. Then, S34 and steps thereafter are executed.

(Control of Scoring Process)

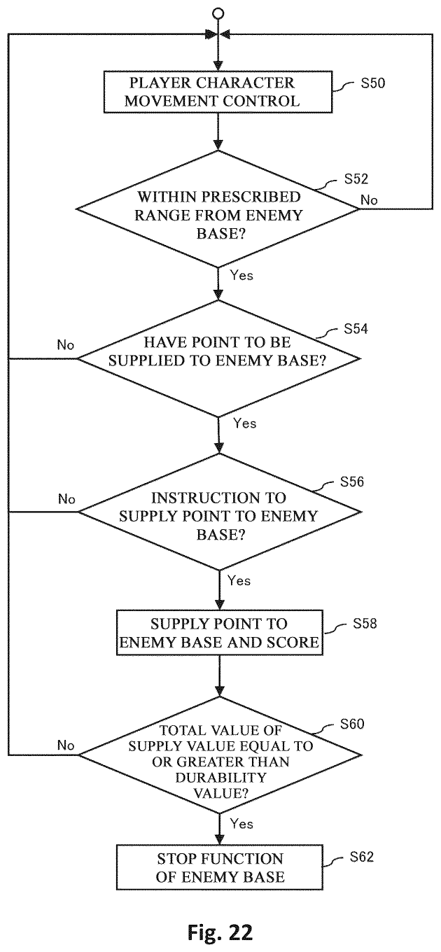

Next, FIG. 22 shows a control flow of a scoring process of points. First, the character action control unit 30 controls the movement of the player character (belonging to the ally team) in the play field 300 in response to an instruction of the player received via the input unit 20 (850). Then, the scoring unit 70 judges whether or not the player character exists within a prescribed range from an enemy base 312 (S52). When the player character does not exist within the prescribed range from the enemy base 312 (No in S52), S50 and steps thereafter are executed.

However, when the player character exists within the prescribed range from an enemy base 312 (Yes in S52), the scoring unit 70 judges whether or not the player of the player character possesses points (S54). When the player does not possess points (No in S54), S50 and steps thereafter are executed. When the player possesses points (Yes in S54), the scoring unit 70 judges whether or not a point supply instruction is received from the player to supply the points to the enemy base 312 via the input unit 20 (S56). When no point supply instruction is received from the player (No in S56), S50 and steps thereafter are executed.

On the other hand, when a point supply instruction is received from the player (Yes in S56), the scoring unit 70 supplies the points possessed by the player to the enemy base 312, and converts the points into a score of the ally team. The scoring unit 70 can directly use a numerical value of the points as the score, or can use a value obtained by multiplying the points by a prescribed coefficient determined according to the remaining time of the game as the score. Furthermore, the scoring unit 70 supplies a supply value corresponding to the score or the points to the enemy base 312 and accumulates the supply values in the enemy base 312 (S58). For example, the scoring unit 70 can directly use a numerical value of the points as the supply value, or can use a value obtained by multiplying the points by a prescribed coefficient determined according to the remaining time of the game as the supply value.

Then, the base control unit 80 is configured to compare a total value of the supply values accumulated in the enemy base 312 by the scoring unit 70 with the durability value preset in the enemy base 312 (S60). Note that the total value of the supply values is a total value of the supply value corresponding to the points supplied to the enemy base 312 by one player character and the supply value corresponding to the points supplied to this enemy base 312 by other player characters of the same team as the one player character. When the base control unit 80 judges that the total value of the supply values is less than the durability value (No in S60), S50 and steps thereafter are executed. However, when the base control unit 80 judges that the total value of the supply values is equal to or greater than the durability value (Yes in S60), the base control unit 80 stops the function of the enemy base 312 (S62). Then, the outcome decision unit 85 ends the game when a prescribed game time has elapsed, and determines the outcome of the game based on the score of each team at the end.

(Example of Point Object)

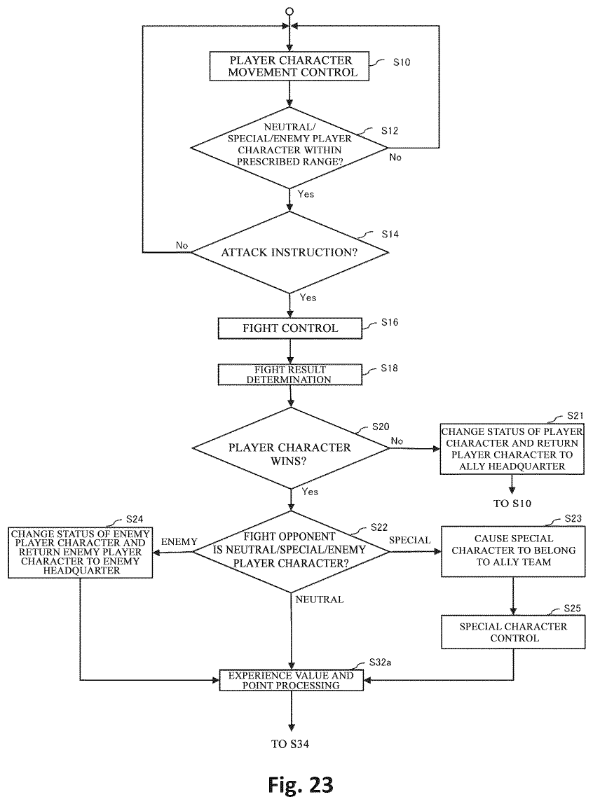

FIG. 23 shows an example of a flow of process in the game system according to the present embodiment. The flow of process in FIG. 23 is similar to the flow of process in FIG. 19, except for process for the case where the player character wins against a neutral character. Therefore, except for the differences, detailed explanations are omitted.

As shown in FIG. 23, when the fight result determination unit 45 determines that the player character won against the target character (Yes in S20), it executes the process in accordance with the type of the target character (S22). The cases where the player character wins against each character are described below.

If the target character is a neutral character (“neutral” in S22), the character state decision unit 50 erases the display of the neutral character from the play field 300. Furthermore, the point giving control unit 62 refers to the points possessed by the player and the upper limit of points that can be possessed, which is set for the player, and also refers to the points associated with the lost neutral character. Then, when the cumulative total of the points that are given to the player is below the upper limit set for the player, the point giving control unit 62 automatically gives the points to the player. On the other hand, when the cumulative total of the points that are given to the player exceeds the upper limit set for the player character, the point giving control unit 62 generates point objects corresponding to the surplus points obtained by subtracting the upper limit from the cumulative total, and makes them appear in the play field (S32a). Note that the experience value giving unit 60 gives the player character a prescribed experience value based on defeating the neutral character (S32a). Furthermore, even when the target character is an enemy player character or a special character, point processing and experience value processing are executed in the same manner as when the target character is a neutral character.

[Game Program]

Each component included in the game system 1 according to the present embodiment shown in FIGS. 1 to 23 can be implemented by causing an arithmetic processing unit such as a central processing unit (CPU) to execute a program (that is, a game program), that is, by processing by software. Each component can also be implemented by writing a program in advance to hardware as an electronic component such as an integrated circuit (IC). The software and the hardware can also be used together.

The game program according to the present embodiment can be incorporated in advance into, for example, IC or ROM. The game program is a file in installable format or executable format, can be recorded in a computer-readable recording medium such as magnetic recording medium, optical recording medium, or semiconductor recording medium, and can also be provided as computer program. The recording medium in which the program is stored may be non-transient recording medium such as CD-ROM or DVD. Further, the game program can also be stored in advance in a computer connected to a communication network such as the Internet so that the game program can be provided by download via the communication network.

The game program according to the present embodiment works on the CPU and the like, and is made to function as the display unit 10, display control unit 15, input unit 20, storage unit 25, character action control unit 30, appearance control unit 35, fight control unit 40, fight result determination unit 45, character state decision unit 50, ally character control unit 55, special character control unit 57, experience value giving unit 60, point giving control unit 62, evolution control unit 64, scoring unit 70, base control unit 80, outcome decision unit 85, restriction generation unit 87, time limit control unit 90, character information storage section 250, team information storage section 252, player information storage section 254, and play field information storage section 256 described with reference to FIGS. 1 to 20.

[Effects of Embodiment]

In the game system 1 according to the present embodiment, the player can acquire points by operating his/her own player character and defeating the neutral character automatically controlled by the system, and can convert the earned points into the score of his/her own team at the base of the opponent team. As a result, in the game system 1, the player can enjoy the game even without performing an interpersonal battle with an opponent player character operated by another player, and can contribute to the team to which the player belongs even without performing an interpersonal battle. That is, in the game system 1, the player can contribute to the team to which the player belongs by an action other than the interpersonal battle (action to defeat the neutral character and the like) in the game, and can improve the skill level of operations required for the interpersonal battle by the action. Therefore, the player can reduce the feeling of being not good at the interpersonal battle by experiencing the battle with the neutral character.

Furthermore, in the game system 1, the player can associate the neutral character defeated by his/her own player character with the player and make the neutral character an ally character, cause the ally character to appear in the play field 300, and cause the ally character to follow movement of the player character and automatically attack another neutral character or an enemy player character. As a result, in the game system 1, the player not only can fight against the neutral character and defeat the neutral character, but also can make the neutral character an ally character and cause the neutral character to fight together with his/her own player character.

Furthermore, in the game system 1, the player can freely select to store the ally character in the character storage area and to cause the ally character to appear in the play field 300 from the character storage area. That is, in the game system 1, as long as before scoring the points possessed by the player, the possessed ally character can be caused to appear in the play field 300 and used as a force to fight together with the player character. As a result, in the game system 1, for example, when the HP of the ally character is high, the ally character can be caused to appear in the play field 300 and fight together, and when the HP becomes low, the ally character can be stored in the character storage area and used for scoring.

Moreover, in the game system 1, points obtained by defeating a neutral character, etc. can be given to the player without objectifying them until the upper limit of points that the player can possess is reached, and point objects obtained by objectifying the points can be made to appear in the play field only when the upper limit is exceeded. That is, until the upper limit is reached, by defeating a neutral character, etc., points associated with the neutral character will be automatically given to the player, and when the player already possesses points up to the upper limit, the points associated with the neutral character, which should be obtained by defeating the neutral character are made to appear around the defeated neutral character as point objects. As a result, it is possible to prevent one player from hoarding a large number of points and to encourage scoring of points as appropriate, so that a seesaw game can be expected to expand between the two teams.

Although the embodiment of the present disclosure has been described above, the embodiment described above does not restrict the invention according to the scope of claims. It should be noted that not all combinations of features described in the embodiment are essential to means for solving the problems of the invention. Further, technical elements of the embodiment described above may be applied alone, or may be divided into a plurality of parts such as a program component and a hardware component so as to be applied.

### REFERENCE SIGNS LIST

1 Game system
3, 3a, 3n Information terminal
5 Communication network
7 Server
10 Display unit
15 Display control unit
20 Input unit
25 Storage unit
30 Character action control unit
35 Appearance control unit
40 Fight control unit
45 Fight result determination unit
50 Character state decision unit
55 Ally character control unit
57 Special character control unit
60 Experience value giving unit
62 Point giving control unit
64 Evolution control unit
70 Scoring unit
80 Base control unit
85 Outcome decision unit
87 Restriction generation unit
90 Time limit control unit
200 Input surface
210 Input control unit
212 Movement instruction input area
214 Direction display area
216 Direction instruction unit
250 Character information storage section
252 Team information storage section
254 Player information storage section
256 Play field information storage section
300 Play field
302 Ally headquarter
304 Enemy headquarter
306 Lane
310 Ally base
312 Enemy base
314 Neutral region
316 Central part
318 Overall view
320 Character storage area
322 Stored character presentation
324 Countdown display
400, 402, 404, 406 Player character
410, 410a Neutral character
412 Ally character
414 First special character
411, 411a, 415 Status
416 Second special character
420 Enemy player character
430, 432 Effect range
500 Ally team score
502 Enemy team score
504 Remaining game time
506 Player score
510, 510a, 511 Status
512, 514, 516, 518 Point display
550 Point object
600 Attack instruction area
602 Skill generation area
700 Return instruction area
800 Performance display
802 Display
900 Restriction area

1. A game system comprising one or more processors, memory and one or more programs that are stored in the memory and executed by the one or more processors for performing a game method, in which an ally team to which a player belongs and an enemy team to which another player belongs compete in a play field, and an outcome of a game is decided by comparing scores earned by the ally team and the enemy team, the one or more programs comprising:
a character state decision unit that is configured to decide a state of a neutral character which acts without being operated by the player and the another player and with which prescribed points are associated, based on a result of a fight in which the neutral character and a player character of the player fight; and
a point giving control unit that is configured to control a giving of the prescribed points associated with the neutral character to the player, based on the state of the neutral character.

2. The game system according to claim 1, wherein the point giving control unit is configured to:
automatically give the prescribed points to the player if a cumulative total of the prescribed points that are given to the player satisfies a first condition in relation to an upper limit set for the player, and
cause a point object to appear in the play field and make the point object available for acquisition by any player of the ally team and the enemy team if the cumulative total of the prescribed points that are given to the player satisfies a second condition in relation to the upper limit set for the player.

3. The game system according to claim 2, wherein if the second condition is a condition where the cumulative total of the prescribed points that are given to the player exceeds the upper limit, the point giving control unit is configured to cause point objects to appear in accordance with a surplus obtained by subtracting the upper limit from the cumulative total.

4. The game system according to claim 1, wherein if a positional relationship between the player character and the point object satisfies a prescribed condition, the point giving control unit is configured to make a point object available for acquisition by the player character.

5. The game system according to claim 4, wherein even if the positional relationship satisfies the prescribed condition, the point giving control unit is configured to prevent the player character of the player whose cumulative total of the prescribed points from satisfying the second condition to acquire the point object.

6. The game system according to claim 1, wherein the neutral character is a special character, when a result of a fight between the player character and the special character indicates a win of the player character, the point giving control unit is configured to cause at least some of the prescribed points to appear in the play field as point objects.

7. The game system according to claim 1, further comprising a scoring unit that is configured to convert points given to the player character into a score of the ally team when the player character is located within a prescribed area provided in the play field.

8. The game system according to claim 7, wherein the prescribed area is an enemy base of the enemy team provided in the play field and a predetermined durability value is set for the enemy base,
when the player character is located in the enemy base, the scoring unit is configured to, in response to a prescribed operation of the player, convert the points possessed by the player character into a score of the ally team, and also supply a supply value corresponding to the score to the enemy base and accumulate the supply value in the enemy base; and
the game system further comprises a base control unit that is configured to stop function of the enemy base when a total value of the supply values accumulated in the enemy base by the scoring unit is equal to or greater than the durability value.

9. A game method performed by a game system comprising one or more processors, memory and one or more programs that are stored in the memory and executed by the one or more processors, in which an ally team to which a player belongs and an enemy team to which another player belongs compete in a play field, and an outcome of a game is decided by comparing scores earned by the ally team and the enemy team, the game method comprising:
deciding a state of a neutral character which acts without being operated by the player and the another player and with which prescribed points are associated, based on a result of a fight in which the neutral character and a player character of the player fight; and
controlling a giving of the prescribed points associated with the neutral character to the player, based on the state of the neutral character.

10. The game method according to claim 9, wherein the method further comprises:
automatically giving the prescribed points to the player if a cumulative total of the prescribed points that are given to the player satisfies a first condition in relation to an upper limit set for the player, and
causing a point object to appear in the play field and make the point object available for acquisition by any player of the ally team and the enemy team if the cumulative total of the prescribed points that are given to the player satisfies a second condition in relation to the upper limit set for the player.

11. The game method according to claim 10, wherein the method further comprises:
if the second condition is a condition where the cumulative total of the prescribed points that are given to the player exceeds the upper limit, causing point objects to appear in accordance with a surplus obtained by subtracting the upper limit from the cumulative total.

12. The game method according to claim 9, wherein the method further comprises:
if a positional relationship between the player character and the point object satisfies a prescribed condition, making a point object available for acquisition by the player character.

13. The game method according to claim 12, wherein the method further comprises:
even if the positional relationship satisfies the prescribed condition, preventing the player character of the player whose cumulative total of the prescribed points from satisfying the second condition to acquire the point object.

14. The game method according to claim 9, wherein the neutral character is a special character, and the method further comprises:
when a result of a fight between the player character and the special character indicates a win of the player character, causing at least some of the prescribed points to appear in the play field as point objects.

15. The game method according to claim 9, wherein the method further comprises:
converting points given to the player character into a score of the ally team when the player character is located within a prescribed area provided in the play field.

16. The game method according to claim 15, wherein the prescribed area is an enemy base of the enemy team provided in the play field and a predetermined durability value is set for the enemy base, and the method further comprises:
when the player character is located in the enemy base, converting the points possessed by the player character into a score of the ally team in response to a prescribed operation of the player,
supplying a supply value corresponding to the score to the enemy base and accumulate the supply value in the enemy base; and
stopping function of the enemy base when a total value of the supply values accumulated in the enemy base by the scoring unit is equal to or greater than the predetermined durability value.

17. A non-transitory computer-readable storage medium for a game system comprising one or more processors and memory, the non-transitory computer-readable storage medium storing one or more programs that are stored in the memory and executed by the one or more processors for performing a game method, in which an ally team to which a player belongs and an enemy team to which another player belongs compete in a play field, and an outcome of a game is decided by comparing scores earned by the ally team and the enemy team, the one or more programs comprising:
a character state decision unit that is configured to decide a state of a neutral character which acts without being operated by the player and the another player and with which prescribed points are associated, based on a result of a fight in which the neutral character and a player character of the player fight; and
a point giving control unit that is configured to control a giving of the prescribed points associated with the neutral character to the player, based on the state of the neutral character.

18. The non-transitory computer-readable storage medium according to claim 17, wherein the point giving control unit is configured to:
automatically give the prescribed points to the player if a cumulative total of the prescribed points that are given to the player satisfies a first condition in relation to an upper limit set for the player, and
cause a point object to appear in the play field and make the point object available for acquisition by any player of the ally team and the enemy team if the cumulative total of the prescribed points that are given to the player satisfies a second condition in relation to the upper limit set for the player.

19. The non-transitory computer-readable storage medium according to claim 18, wherein if the second condition is a condition where the cumulative total of the prescribed points that are given to the player exceeds the upper limit, the point giving control unit is configured to cause point objects to appear in accordance with a surplus obtained by subtracting the upper limit from the cumulative total.

20. The non-transitory computer-readable storage medium according to claim 17, wherein if a positional relationship between the player character and the point object satisfies a prescribed condition, the point giving control unit is configured to make a point object available for acquisition by the player character.
